(19) United States
(12) Patent Application Publication
(10) Pub. No.: US 2024/0021915 A1
(43) Pub. Date: Jan. 18, 2024

(54) BATTERY TEMPERATURE ADJUSTING DEVICE

(71) Applicant: AISAN KOGYO KABUSHIKI KAISHA, Obu-shi (JP)

(72) Inventors: Mamoru YOSHIOKA, Obu-shi (JP); Shinji KAWAI, Gifu-shi (JP)

(73) Assignee: AISAN KOGYO KABUSHIKI KAISHA, Obu-shi (JP)

(21) Appl. No.: 18/346,361

(22) Filed: Jul. 3, 2023

(30) Foreign Application Priority Data
Jul. 14, 2022 (JP) 2022-113427

(51) Int. Cl. H01M 10/6568; H01M 10/615; H01M 10/613; H01M 10/63

(52) U.S. Cl. CPC H01M 10/6568; H01M 10/615; H01M 10/613; H01M 10/63

(57) ABSTRACT

A battery temperature adjusting device includes a battery pack, a heat-exchange part for exchanging heat between the battery pack and a heat medium, and a heat medium circuit for flowing the heat medium to the heat-exchange part to adjust the temperature of the battery pack by flowing the heat medium to the heat-exchange part through the heat medium circuit to exchange heat with the battery pack. The heat medium circuit includes a warming circuit for flowing a warming medium to the heat-exchange part to warm the battery pack, and a cooling circuit for flowing a cooling medium to the heat-exchange part to cool the battery pack. The battery temperature adjusting device further includes a circuit switching unit switches between the circuits to connect the warming circuit to the heat-exchange part in warming the battery pack or to connect the cooling circuit to the heat-exchange part in cooling the battery pack.

### CROSS-REFERENCE TO RELATED APPLICATIONS

This application is based upon and claims the benefit of priority to Japanese Patent Application No. 2022-113427 filed on Jul. 14, 2022, the entire contents of which are incorporated herein by reference.

### BACKGROUND

### Technical Field

The present disclosure relates to a battery temperature adjusting device configured to primarily adjust the temperature of a secondary battery that can be charged and discharged.

### Related Art

As a conventional art of the above type, for example, there is known a battery temperature adjusting device disclosed in Japanese unexamined patent application publication No. 2021-044135 (JP2021-044135A). This device is configured to adjust the temperature of a battery pack including a plurality of battery cells by exchanging heat between the battery cells with a heat medium. Here, the temperatures of the battery cells are different depending on layout, or arrangement, of the battery cells in the battery pack. Therefore, this device is configured as below to adjust the temperatures of the battery cells so that they are close to each other after temperature adjustment.

Specifically, this device is provided with a battery pack, a heat medium circuit, and a heat-transfer amount adjusting unit. The battery pack includes a first battery cell, a second battery cell electrically connected to the first battery cell, a first heat-exchange part for exchanging heat between the first battery cell and the heat medium (refrigerant), and a second heat-exchange part for exchanging heat between the second battery cell and the refrigerant. The heat medium circuit is arranged to flow the refrigerant at the adjusted temperature to the first heat-exchange part and the second heat-exchange part. Here, if the temperatures of the first and second battery cells are not adjusted, a temperature difference is generated between the first battery cell and the second battery cell due to the heat generated by charge and discharge under predetermined usage conditions. The heat-transfer amount adjusting unit is configured to adjust a first heat-transfer amount between the first battery cell and the refrigerant and a second heat-transfer amount between the second battery cell and the refrigerant so that the temperature difference between the first battery cell and the second battery cell after temperature adjustment is smaller than that when those first and second battery cells are not adjusted under the predetermined usage conditions.

### SUMMARY

### Technical Problems

The aforementioned battery temperature adjusting device disclosed in JP2021-044135A is configured to cool, using the refrigerant, the battery cells that generate heat during charge and discharge, thereby reducing a temperature difference between the battery cells in consideration of the layout of the battery cells; however, this technique does not disclose the technique of warming the battery cells during a cold period. Considering year-round use of batteries, both operations of cooling and warming the batteries are necessary in order to adjust the batteries to a proper temperature. Thus, there is a demand to provide a battery temperature adjusting device that can realize those operations.

The present disclosure has been made to address the above problems and has a purpose to provide a battery temperature adjusting device capable of adjusting the temperature of a battery by selectively cooling or warming the battery in response to a request for adjusting the temperature of a battery, which will be referred to as a battery temperature adjusting request.

### Means of Solving the Problems

To achieve the above purpose, one aspect of the present disclosure provides a battery temperature adjusting device comprising: a battery; a heat-exchange part configured to exchange heat between the battery and a heat medium; and a heat medium circuit configured to flow the heat medium to the heat-exchange part, the battery temperature adjusting device being configured to adjust a temperature of the battery by flowing the heat medium to the heat-exchange part through the heat medium circuit to exchange heat with the battery, wherein the heat medium circuit includes: a warming circuit configured to flow the heat medium with a raised temperature to the heat-exchange part to warm the battery; and a cooling circuit configured to flow the heat medium cooled to the heat-exchange part to cool the battery, and the battery temperature adjusting device further comprises a circuit switching unit configured to switch between the warming circuit and the cooling circuit to connect the warming circuit to the heat-exchange part when warming the battery and to connect the cooling circuit to the heat-exchange part when cooling the battery.

According to the above configuration, the heat medium circuit for flowing the heat medium to the heat-exchange part includes the warming circuit for flowing the temperature-increased heat medium (namely, a warming medium) to the heat-exchange part to warm the battery and the cooling circuit for flowing the cooled heat medium (namely, a cooling medium) to the heat-exchange part to cool the battery. When warming the battery, the circuit switching unit switches to connecting the warming circuit to the heat-exchange part, allowing the warming medium to flow to the heat-exchange part. Alternatively, when cooling the battery, the circuit switching unit switches to connecting the cooling circuit to the heat-exchange part, allowing the cooling medium to flow to the heat-exchange part.

The above-described aspect can selectively cool or warm the battery in response to a request for temperature adjustment of a battery.

### BRIEF DESCRIPTION OF THE DRAWINGS

FIG. 1 is a schematic diagram showing a battery temperature adjusting device in a first embodiment;

FIG. 2 is a schematic diagram showing a battery stack in the first embodiment;

FIG. 3 is a flowchart showing contents of a battery-pack warming-cooling control in the first embodiment;

FIG. 4 is a schematic diagram showing a flow of a cooling medium in the battery temperature adjusting device in a second operation mode in the first embodiment;

FIG. 5 is a schematic diagram showing a flow of a warming medium in the battery temperature adjusting device in a first operation mode in the first embodiment;

FIG. 6 is a schematic diagram showing a state of the battery stack in the second operation mode in the first embodiment, similar to FIG. 2;

FIG. 7 is a schematic diagram showing a state of the battery stack in the first operation mode in the first embodiment, similar to FIG. 2;

FIG. 8 is a schematic diagram showing a state of a battery stack in the first operation mode in a second embodiment, similar to FIG. 7;

FIG. 9 is a schematic diagram showing a state of the battery stack in the second operation mode in the second embodiment, similar to FIG. 6;

FIG. 10 is a schematic diagram showing a battery temperature adjusting device in a third embodiment;

FIG. 11 is a cross-sectional diagram showing a six-way valve in a fourth embodiment;

FIG. 12 is a cross-sectional view showing the six-way valve in the fourth embodiment;

FIG. 13 is a schematic diagram showing a battery temperature adjusting device in a fifth embodiment;

FIG. 14 is a flowchart showing contents of battery-pack cooling control in the firth embodiment;

FIG. 15 is a graph showing results of temperature control of a battery pack under the battery-pack cooling control in the fifth embodiment;

FIG. 16 is a graph showing results of temperature control of the battery pack under the battery-pack cooling control in the fifth embodiment;

FIG. 17 is a flowchart showing contents of battery-pack cooling control in a sixth embodiment;

FIG. 18 is a flowchart showing contents of a battery-pack warming-cooling control in a seventh embodiment;

FIG. 19 is a schematic diagram showing a battery temperature adjusting device in an eighth embodiment;

FIG. 20 is a schematic diagram showing a battery temperature adjusting device in a ninth embodiment;

FIG. 21 is a schematic diagram showing a battery temperature adjusting device in a tenth embodiment;

FIG. 22 is a schematic diagram showing a battery temperature adjusting device in an eleventh embodiment;

FIG. 23 is a schematic diagram showing a battery temperature adjusting device in a twelfth embodiment; and

FIG. 24 is a schematic diagram showing a battery temperature adjusting device in a thirteenth embodiment.

### DETAILED DESCRIPTION OF THE EXEMPLARY EMBODIMENTS

A detailed description of several embodiments of a battery temperature adjusting device will now be given referring to the accompanying drawings.

### First Embodiment

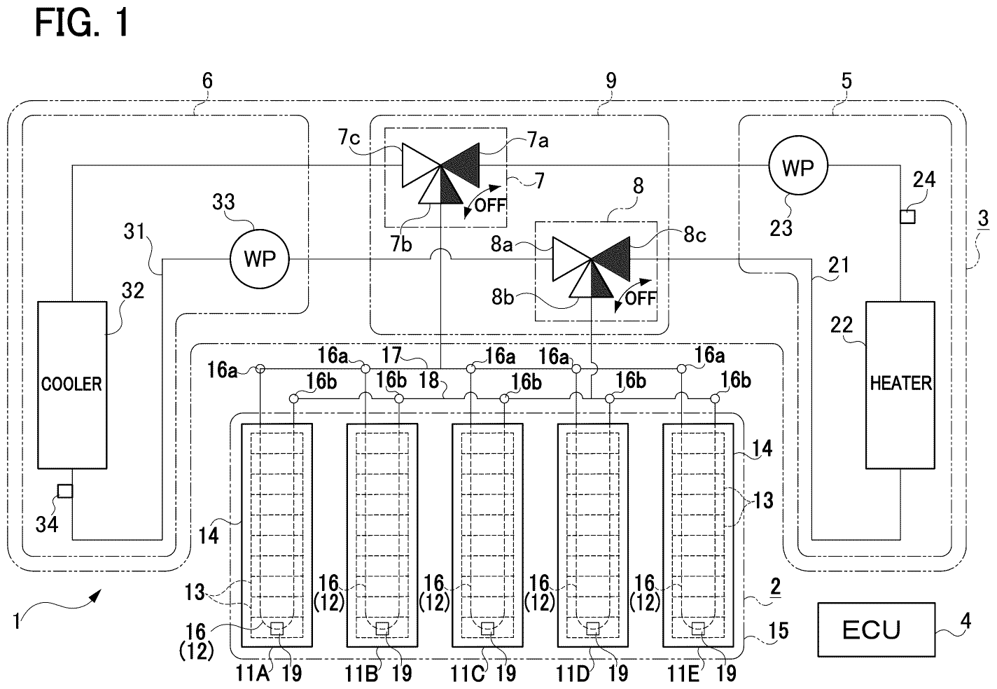

A first embodiment will be described first referring to FIGS. 1 to 7. In the following description, as one example, a battery temperature adjusting device is explained to adjust the temperature of a battery, e.g., a secondary battery, which will be mounted in an electric vehicle.

### Overview of Battery Temperature Adjusting Device

FIG. 1 is a schematic diagram of a battery temperature adjusting device 1 in this embodiment. This battery temperature adjusting device 1 is schematically provided with a single battery pack 2, a heat medium circuit 3, and an electronic control unit (ECU) 4 for controlling a flow of a heat medium in the heat medium circuit 3. The battery pack 2 corresponds to one example of a battery of the present disclosure. The battery pack 2 in the present embodiment includes a plurality of battery stacks 11A to 11E arranged in parallel, and a plurality of heat-exchange parts 12 individually provided in the battery stacks 11A to 11E to exchange heat between the battery stack 11A to 11E and the heat medium. The heat medium circuit 3 is configured to flow the heat medium to the heat-exchange parts 12. In the present embodiment, the heat medium is composed of water, for example. This battery temperature adjusting device 1 is configured such that the heat medium circuit 3 flows the heat medium to the heat-exchange parts 12 to exchange heat with each of the battery stacks 11A to 11E in order to adjust the temperature of each of the battery stacks 11A to 11E, and hence control the temperature of the battery pack 2. In the battery pack 2 in FIG. 1, the spacing between adjacent battery stacks 11A to 11E is illustrated wide for convenience, but the actual spacing is narrow. The same applies to other figures which will be described below.

### Battery Stack

In the present embodiment, each of the battery stacks 11A to 11E is constituted of a plurality of battery cells 13 arranged in a row and accommodated in a case 14. In FIG. 1, the battery cells 13 and the case 14 are illustrated by an example in each of the battery stacks 11A and 11E. These battery stacks 11A to 11E are accommodated in a single housing 15 to form a single heat-exchange part 12. Each of the battery stacks 11A to 11E has stack electrodes (not shown) connected in parallel with the electrodes of each battery cell 13. In this embodiment, each battery cell 13 is provided with a cell temperature sensor 19 for detecting the temperature of the corresponding battery cell 13, referred to as a battery cell temperature TBCX. In FIG. 1, only one cell temperature sensor 19 is illustrated by an example in each of the battery stacks 11A to 11E for convenience.

### Heat-Exchanging Part

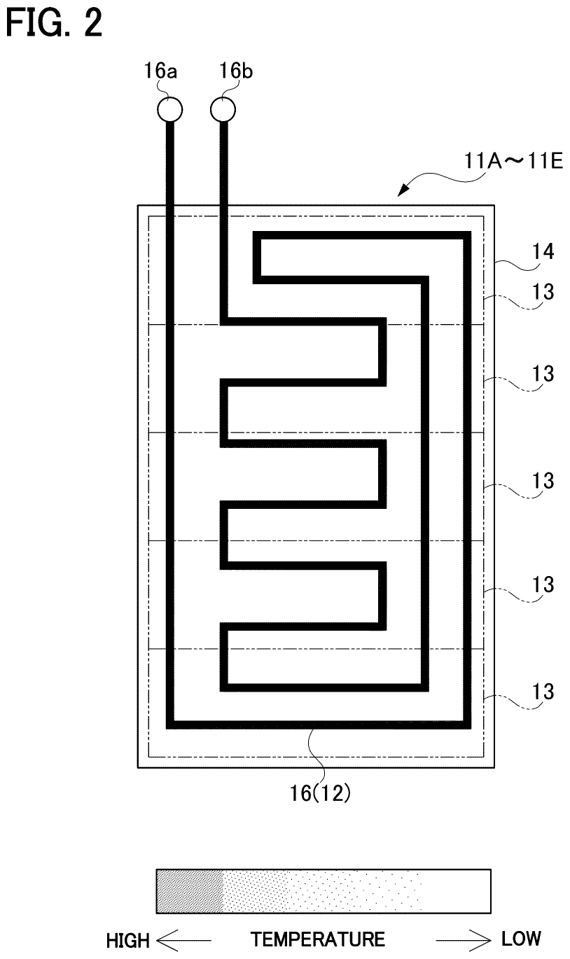

FIG. 2 is a schematic diagram showing the battery stacks 11A to 11E. As shown in FIG. 2, the heat-exchange part 12 in each of the battery stacks 11A to 11E is constituted of a heat-exchange pipe 16 including a first input/output port 16a for heat medium at one end and a second input/output 16b for heat medium at the other end. This heat-exchange pipe 16 is arranged to extend from the first input/output port 16a, go around a region of a corresponding one of the battery stacks 11A to 11E near its outer circumference (i.e., an outer circumferential region), further around a region of the battery stack 11A to 11E near its center (i.e., a central region), and then reach the second input/output 16b. Specifically, as shown in FIG. 2, the heat-exchange pipe 16 extending from the first input/output port 16a to the inside of the corresponding battery stack 11A to 11E is arranged to extend almost one turn along the outer circumference of the battery stack 11A to 11E, turn back almost a half turn, and further turns in a zigzag pattern over the center of the battery stack 11A to 11E to reach the second input/output 16b. With this configuration, each heat-exchange pipe 16 is arranged to flow the heat medium to the battery cells 13 arranged in a row in each battery stack 11A to 11E. In the present embodiment, as shown in FIG. 1, the first input/output ports 16a for the battery stacks 11A to 11E are connected in parallel to a first common pipe 17, and the second input/output ports 16b for the battery stacks 11A to 11E are connected in parallel to a second common pipe 18.

With the foregoing arrangement, each heat-exchange pipe 16 allows the heat medium flowing in from the first input/output port 16a to flow near the outer circumference and then near the center of each battery stack 11A to 11E, and finally flow out through the second input/output 16b. Thus, in each battery cell 13, the heat medium flows near the outer circumference and then flows near the center. In contrast, the heat medium flowing in the second input/output 16b flows near the center and then near the outer circumference, and finally flows out from the first input/output port 16a. Thus, in each battery cell 13, the heat medium flows near the center and then flows near the outer circumference.

### Heat-Exchange Medium Circuit

As shown in FIG. 1, the heat medium circuit 3 in the present embodiment is provided with a warming circuit 5, a cooling circuit 6, and a circuit switching unit 9 including a first three-way valve 7 and a second three-way valve 8. The warming circuit 5 includes a warming pipe 21, a heater 22 for heating the heat medium in the warming pipe 21, an electrically-driven first pump 23 that pumps the heat medium (the warming medium) with a temperature raised by the heater 22 through the warming pipe 21, and a first medium temperature sensor 24 provided in the warming pipe 21 between the heater 22 and the first pump 23 to detect the temperature of the warming medium, i.e., a warming medium temperature HTHW. As the heater 22, for example, an electrically operated heater can be used. The cooling circuit 6 includes a cooling pipe 31, a cooler 32 for cooling the heat medium in the cooling pipe 31, an electrically-driven second pump 33 that pumps the heat medium (the cooling medium) cooled by the cooler 32 through the cooling pipe 31, and a second medium temperature sensor 34 provided in the cooling pipe 31 between the cooler 32 and the second pump 33 to detect the temperature of the cooling medium, i.e., a cooling medium temperature CTHW. As the cooler 32, for example, an electrically operated cooler can be used.

The first three-way valve 7 includes a first port 7a, a second port 7b, and a third port 7c. The second three-way valve 8 includes a first port 8a, a second port 8b, and a third port 8c. One end of the warming pipe 21 is connected to the first port 7a of the first three-way valve 7, while the other end of the warming pipe 21 is connected to the third port 8c of the second three-way valve 8. The first common pipe 17 is connected to the second port 7b of the first three-way valve 7. One end of the cooling pipe 31 is connected to the first port 8a of the second three-way valve 8, while the other end of the cooling pipe 31 is connected to the third port 7c of the first three-way valve 7. The second common pipe 18 is connected to the second port 8b of the second three-way valve 8. As the first three-way valve 7 and the second three-way valve 8, for example, electrically operated valves can be used.

Here, the first three-way valve 7 and the second three-way valve 8 switches to connecting the warming circuit 5 to each heat-exchange pipe 16 when each battery stack 11A to 11E is to be warmed, and switches to connecting the cooling circuit 6 to each heat-exchange pipe 16 when each battery stack 11A to 11E is to be cooled.

With the above configuration, the warming circuit 5 is configured to cause the first pump 23 to pressure feed the warming medium with a temperature raised by the heater 22 to each heat-exchange pipe 16 in order to warm the battery stacks 11A to 11E. The cooling circuit 6 is configured to cause the second pump 33 to pressure feed the cooling medium cooled by the cooler 32 to each heat-exchange pipe 16 in order to cool the battery stacks 11A to 11E.

### Electrical Structure of Battery Temperature Adjusting Device

In the present embodiment, the ECU4 controls the battery temperature adjusting device and corresponds to one example of a control unit of the present disclosure. Specifically, the first medium temperature sensor 24, the second medium temperature sensor 34, and a number of cell temperature sensors 19, are individually connected to the ECU 4. The first three-way valve 7, the second three-way valve 8, the heater 22, the first pump 23, the cooler 32, and the second pump 33 are also individually connected to the ECU 4. The ECU 4 controls those first three-way valve 7, second three-way valve 8, heater 22, first pump 23, cooler 32, and second pump 33 based on detected values of the corresponding sensors 19, 24, and 34.

Here, it is assumed that the battery pack 2 tends to decrease in performance as the temperature of each battery cell 13 is lower, and deteriorate when each battery cell 13 is used at 25° C. or higher, for example. Therefore, in order to ensure the performance of battery pack 2, it is necessary to use each battery cell 13 at around 25° C. as much as possible. To satisfy the above issues no matter how an electric vehicle is operated under any environmental conditions, consequently, the heat medium circuit 3 needs an enhanced performance or an increase size. However, this may result in higher cost and larger size (which worsens the ease of installation in a vehicle) of the battery temperature adjusting device 1. In the present embodiment, therefore, the ECU 4 executes the following control to warm and cool a battery pack 2, which will be referred to as a battery-pack warming-cooling control, in order to maximize the performance of the heat medium circuit 3, and ensure the performance and suppress the deterioration of the battery pack 2 at low costs.

### Battery-Pack Warming-Cooling Control

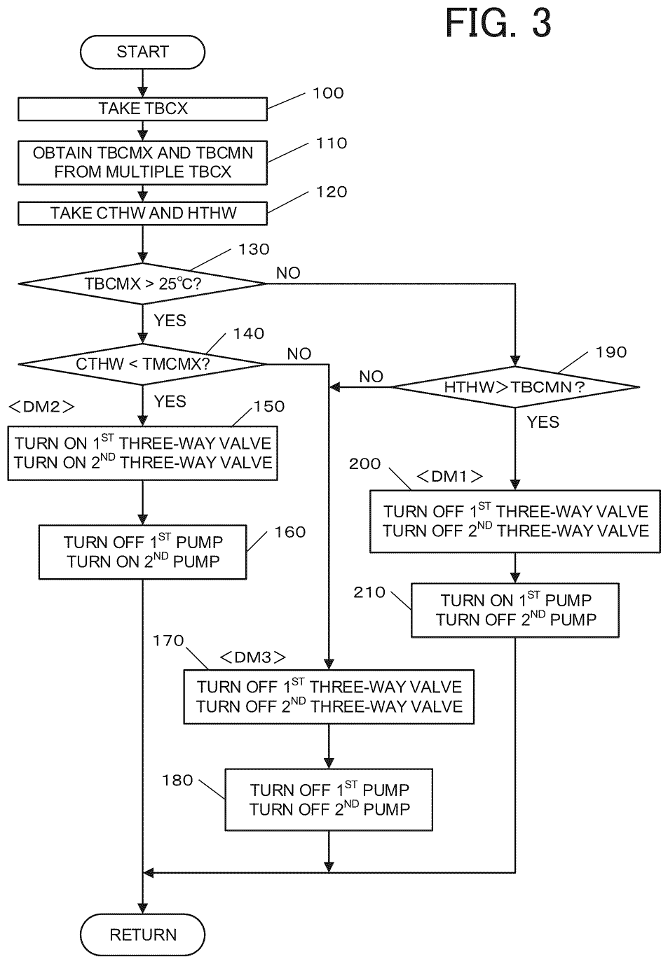

FIG. 3 is a flowchart showing one example of the battery-pack warming-cooling control. When the process enters this routine, in step 100, the ECU 4 takes the battery cell temperatures TBCX detected by the cell temperature sensors 19 of the battery cells 13 in each of the battery stacks 11A to 11E.

In next step 110, the ECU 4 obtains a highest battery cell temperature TBCMX and a lowest battery cell temperature TBCMN from among the multiple battery cell temperatures TBCX taken in step 100.

In step 120, the ECU 4 takes the cooling medium temperature CTHW detected by the second medium temperature sensor 34 of the cooling circuit 6 and the warming medium temperature HTHW detected by the first medium temperature sensor 24 of the warming circuit 5.

In step 130, the ECU 4 determines whether or not the highest battery cell temperature TBCMX is higher than 25° C., which is a criterion for battery deterioration. When this determination result is affirmative (YES) in step 130, the ECU 4 proceeds to step 140. When this determination result is negative (NO) in step 130, the ECU 4 proceeds to step 190.

In step 140, the ECU 4 determines whether or not the cooling medium temperature CTHW is lower than the highest battery cell temperature TBCMX. When YES in step 140, the ECU 4 proceeds to step 150 to execute an operation mode 2 (DM2). When NO in step 140, the ECU 4 proceeds to step 170 to execute an operation mode 3 (DM3).

In the operation mode 2 (DM2), in step 150, the ECU 4 turns on the first three-way valve 7 and turns on the second three-way valve 8.

In the operation mode 2 (DM2), in step 160, the ECU 4 turns off the first pump 23 and turns on the second pump 33. Then, the ECU 4 returns to step 100.

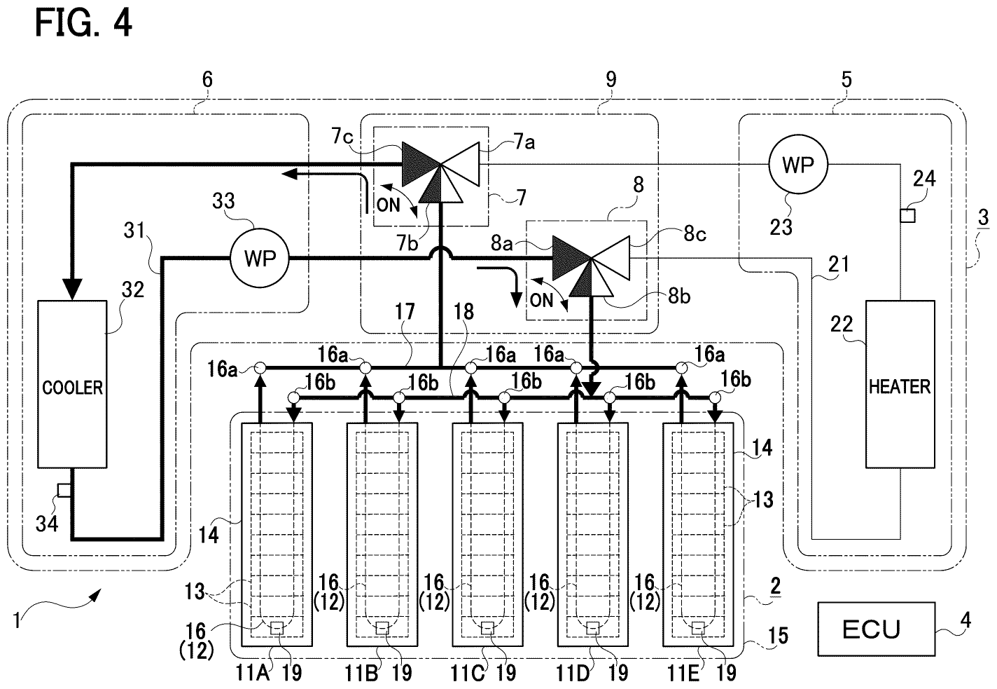

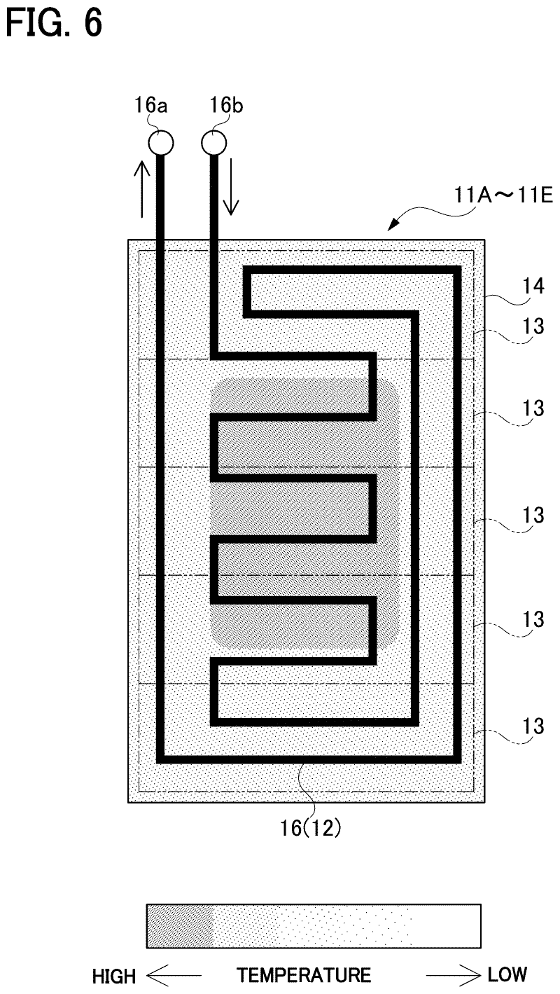

FIG. 4 is a schematic diagram showing a flow of the cooling medium in the battery temperature adjusting device 1 in the operation mode 2 (DM2). In this case, as indicated by arrows in FIG. 4, the cooling medium flowing from the cooling circuit 6 to the battery pack 2 flows in the heat-exchange pipes 16 through the second input/output ports 16b and flows out from the heat-exchange pipes 16 through the first input/output ports 16a in the battery stacks 11A to 11E. This flowing direction of cooling medium in the battery stacks 11A to 11E in this mode is indicated by arrows in FIG. 6. This FIG. 6 is a schematic diagram, similar to FIG. 2, showing the state of each battery stack 11A to 11E in the operation mode 2 (DM2). In this case, each battery stack 11A to 11E has a higher temperature in a region closer to the center, i.e., in the central region, and thus the cooling medium flows first to the central region higher in temperature than other regions, thereby cooling the central region.

In contrast, in step 170 following step 140, in the operation mode 3 (DM3), the ECU 4 turns off the first three-way valve 7 and turns off the second three-way valve 8.

In the operation mode 3 (DM3), in step 180, the ECU 4 turns off the first pump 23 and turns off the second pump 33. Then, the ECU 4 returns to step 100.

FIG. 1 shows the state of the battery temperature adjusting device 1 in this operation mode 3 (DM3). In this case, as shown in FIG. 1, no heat medium flows from both the cooling circuit 6 and the warming circuit 5 to the battery pack 2.

In contrast, in step 190 following step 130, the ECU 4 determines whether or not the warming medium temperature HTHW is higher than the lowest battery cell temperature TBCMN. When YES in step 190, the ECU 4 proceeds to step 200 to execute the operation mode 1 (DM1). When NO in step 190, the ECU 4 proceeds to step 170 to execute the operation mode 3 (DM3).

In the operation mode 1 (DM1), in step 200, the ECU 4 turns off the first three-way valve 7 and turns off the second three-way valve 8.

In the operation mode 1 (DM1), in step 210, the ECU 4 turns on the first pump 23 and turns off the second pump 33. Then, the ECU 4 returns to step 100.

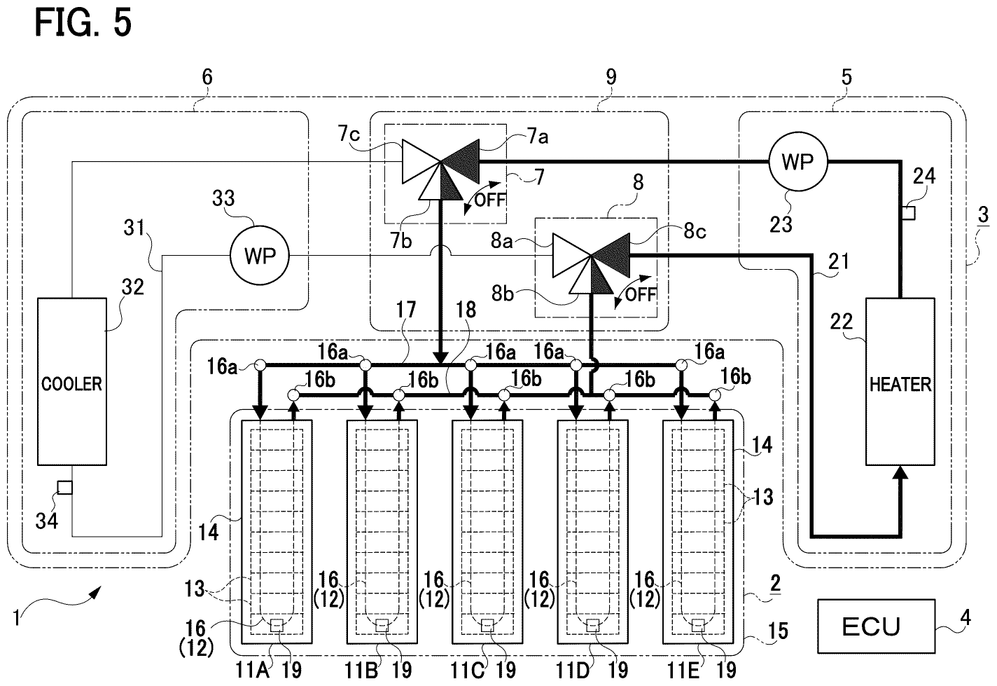

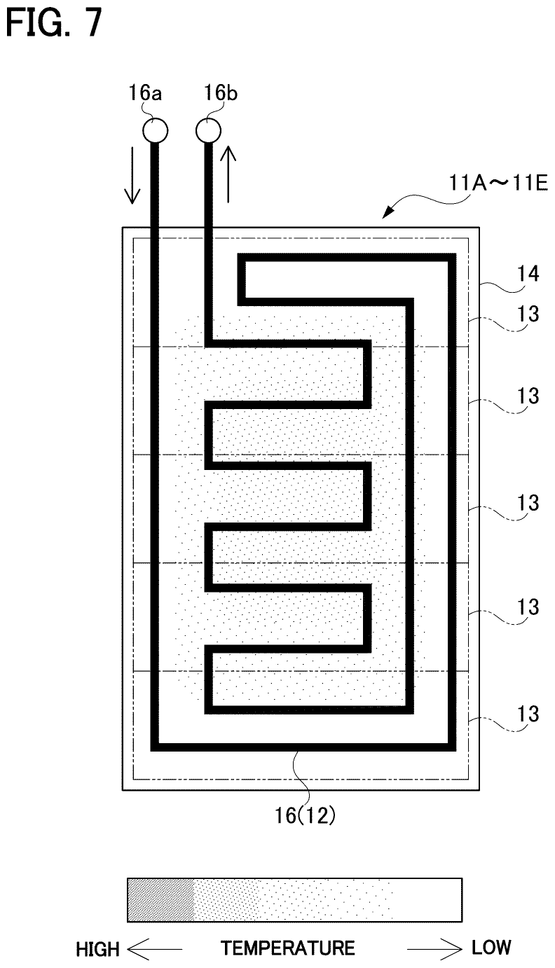

FIG. 5 is a schematic diagram showing a flow of the warming medium in the battery temperature adjusting device 1 in the operation mode 1 (DM1). In this case, the warming medium flowing from the warming circuit 5 to the battery pack 2 flows into the heat-exchange pipes 16 through the first input/output ports 16a and then flows out from the heat-exchange pipes 16 through the second input/output ports 16b in the battery stacks 11A to 11E, as indicated by arrows in FIG. 5. This flowing direction of the warming medium in each battery stack 11A to 11E is shown by arrows in FIG. 7, which is a schematic diagram, similar to FIG. 2, showing the state of each battery stack 11A to 11E in the operation mode 1 (DM1). In this case, each battery stack 11A to 11E has a lower temperature in a region close to the outer circumference, i.e., in the outer circumferential region, and thus the warming medium flows first to the outer circumferential region lower in temperature than other regions, thereby warming the outer circumferential region.

According to the above battery-pack warming-cooling control, the ECU 4 takes the temperatures of the battery cells 13 constituting the battery pack 2, i.e., the battery cell temperatures TBCX, the temperature of the cooling medium flowing from the cooling circuit 6 to the battery pack 2, i.e., the cooling medium temperature CTHW, and the temperature of the warming medium flowing from the warming circuit 5 to the battery pack 2, i.e., the warming medium temperature HTHW. When the battery pack 2 needs to be warmed, i.e., the highest battery cell temperature TBCMX is below 25° C., and further when the warming medium temperature HTHW is higher than the lowest battery cell temperature TBCMN among the temperatures of all the battery cells 13, the ECU 4 executes the operation mode 1 (DM1). Specifically, the ECU 4 controls the first three-way valve 7, second three-way valve 8, first pump 23, and second pump 33 to continue to warm the battery pack 2 and flow the warming medium from the warming circuit 5 to the battery pack 2. In this case, even if the warming medium temperature HTHW is low, but if it is higher than the lowest battery cell temperature TBCMN, this warming medium is effective in warming the battery pack 2, thus ensuring the performance of the battery pack 2.

In contrast, when the battery pack 2 needs to be cooled, i.e., the highest battery cell temperature TBCMX is higher than 25° C., and further when the cooling medium temperature CTHW is lower than the highest battery cell temperature TBCMX, the ECU 4 executes the operation mode 2 (DM2). Specifically, the ECU 4 controls the first three-way valve 7, second three-way valve 8, first pump 23, and second pump 33 to continue to cool the battery pack 2 and flow the cooling medium from the cooling circuit 6 to the battery pack 2. In this case, even if the cooling medium temperature CTHW is high, but if it is lower than the highest battery cell temperature TBCMX, this cooling medium is effective in cooling the battery pack 2, thus suppressing deterioration of the battery pack 2.

Further, The ECU 4 executes the operation mode 3 (DM3) except when performing the foregoing operation mode 1 and operation mode 2. Specifically, the ECU 4 controls the first three-way valve 7, second three-way valve 8, first pump 23, and second pump 33 to stop warming and cooling of the battery pack 2 using the warming medium and the cooling medium. Here, for switching from the operation mode 2 to the operation mode 3, if the second pump 33 is turned off while the three-way valves 7 and 8 remain in the on-state, the cooling function on the battery pack 2 can be stopped. However, in the present embodiment, the three-way valves 7 and 8 are turned off simultaneously at that time, preventing unnecessary power consumption.

Furthermore, the ECU 4 turns off both the three-way valves 7 and 8 in the operation mode 1. When the battery pack 2 has low battery performance that needs to be warmed, both the three-way valves 7 and 8 are turned off, so that the load on the battery pack 2 can be reduced.

### Operations and Effects of the Battery Temperature Adjusting Device

According to the battery temperature adjusting device 1 configured as above in the first embodiment described above, the heat medium circuit 3 for flowing the warming medium to the heat-exchange parts 12, i.e., the heat-exchange pipes 16, includes the warming circuit 5 configured to flow the heat medium with a raised temperature, i.e., the warming medium, to the heat-exchange pipes 16 to warm the battery pack 2, and the cooling circuit 6 configured to flow the heat medium cooled, i.e., the cooling medium, to the heat-exchange pipes 16 to cool the battery pack 2. When warming the battery pack 2, the circuit switching unit 9 switches between the warming circuit 5 and the cooling circuit 6 to connect the warming circuit 5 to the heat-exchange pipes 16, allowing the warming medium to flow to the heat-exchange pipes 16. In contrast, when cooling the battery pack 2, the circuit switching unit 9 switches between the circuits 5 and 6 to connect the cooling circuit 6 to the heat-exchange pipes 16, allowing the cooling medium to flow to the heat-exchange pipes 16. This makes it possible to selectively cool or warm the battery pack 2 in response to a request for adjusting the temperature of the battery pack 2 (the battery).

According to the configuration in this embodiment, when warming the battery pack 2, the circuit switching unit 9 switches between the circuits 5 and 6 to connect the heat-exchange parts 12 (i.e., the heat-exchange pipes 16) in the battery stacks 11A to 11E to the warming circuit 5, allowing the warming medium to flow to the heat-exchange pipe 16 in each of the battery stacks 11A to 11E. When cooling the battery pack 2, the circuit switching unit 9 switches between the circuits 5 and 6 to connect the heat-exchange pipes 16 in the battery stacks 11A to 11E to the cooling circuit 6, allowing the cooling medium to flow to the heat-exchange pipe 16 in each of the battery stacks 11A to 11E. This configuration can selectively cool or warm each of the battery stacks 11A to 11E constituting the battery pack 2.

According to the configuration in the present embodiment, when the heat medium flows in the heat-exchange pipes 16 through the first input/output ports 16a, the heat medium first circulates through the outer circumferential region of each battery stack 11A to 11E, then circulates through the central region of each battery stack 11A to 11E, and finally flows out through the second input/output ports 16b. In contrast, when the heat medium flows in the heat-exchange pipes 16 through the second input/output ports 16b, the heat medium first circulates through the central region of each battery stack 11A to 11E, then circulates through the outer circumferential region of each battery stack 11A to 11E, and finally flows out through the first input/output ports 16a. Thus, the heat medium flowing in the heat-exchange pipes 16 through the first input/output ports 16a first exchanges heat with the outer circumferential regions of the corresponding battery stacks 11A to 11E near the outer circumference, and then with the central regions of the corresponding battery stacks 11A to 11E near the center. Further, the heat medium flowing in the heat-exchange pipes 16 through the second input/output ports 16b first exchanges heat with the central regions of the corresponding battery stack 11A to 11E near the center, and then with the outer circumferential regions of the corresponding battery stacks 11A to 11E near the outer circumference. By selectively flowing the heat medium to the first input/output ports 16a and the second input/output ports 16b, either one selected from the outer circumferential region or the central region of each battery stack 11A to 11E can exchange heat with the heat medium prior to the other.

According to the present embodiment configured as above, when warming the battery pack 2, the circuit switching unit 9 switches to allowing the warming medium to flow in the heat-exchange pipes 16 through the first input/output ports 16a and flow out from the heat-exchange pipes 16 through the second input/output ports 16b. In contrast, when cooling the battery pack 2, the circuit switching unit 9 switches to allowing the cooling medium to flow into the heat-exchange pipes 16 through the second input/output ports 16b and flow out from the heat-exchange pipes 16 through the first input/output ports 16a. Therefore, when warming the battery pack 2, the warming medium flows in the heat-exchange pipes 16 through the first input/output ports 16a, enabling to individually warm the outer circumferential regions of the battery stacks 11A to 11E constituting the battery pack 2 first, and then warm the central regions of the battery stacks 11A to 11E. In contrast, when cooling the battery pack 2, the cooling medium flows in the heat-exchange pipes 16 through the second input/output ports 16b, enabling to individually cool the central regions of the battery stacks 11A to 11E constituting the battery pack 2, and then cool the outer circumferential regions of the battery stacks 11A to 11E. Consequently, when warming the battery pack 2, the outer circumferential region of each battery stack 11A to 11E constituting the battery pack 2 can be effectively warmed prior to the central region. When cooling the battery pack 2, the central region of each battery stack 11A to 11E constituting the battery pack 2 can be effectively cooled prior to the outer circumferential region.

According to the present embodiment configured as above, when warming the battery pack 2, the heat-exchange pipes 16 are connected to the warming circuit 5 by the circuit switching unit 9 to allow the warming medium to flow in the heat-exchange pipes 16 through the first input/output ports 16a, so that this warming medium circulates through the outer circumferential region of each battery stack 11A to 11E constituting the battery pack 2 first and then circulates through the central region of each battery stack 11A to 11E constituting the battery pack 2, and finally flows out through the second input/output 16b. In contrast, when cooling the battery pack 2, the heat-exchange pipes 16 are connected to the cooling circuit 6 by the circuit switching unit 9 to allow the cooling medium to flow in the heat-exchange pipes 16 through the second input/output ports 16b, so that this cooling medium circulates through the central region of each battery stack 11A to 11E constituting the battery pack 2, and then circulates through the outer circumferential region of each battery stack 11A to 11E, and finally flows out through the first input/output port 16a. Thus, when warming the battery pack 2, the outer circumferential region of each battery stack 11A to 11E constituting the battery pack 2 can be effectively warmed prior to the central region. When cooling the battery pack 2, the central region of each battery stack 11A to 11E constituting the battery pack 2 can be effectively cooled prior to the outer circumferential region.

Here, when it is requested to warm the battery pack 2 or each battery stack 11A to 11E, it is preferable to warm the outer circumferential region first, which is lower in temperature than the central region of the battery pack 2 or each battery stack 11A to 11E. Alternatively, when it is requested to cool the battery pack 2 or each battery stack 11A to 11E, it is preferable to cool first the central region first, which is higher in temperature than the outer circumferential region of the battery pack 2 or each battery stack 11A to 11E. In the present embodiment, when warming the battery pack 2, the outer circumferential region with a lower temperature than the central region in each battery stack 11A to 11E is warmed prior to the central region, so that each battery stack 11A to 11E and hence the battery pack 2 can be effectively warmed up. In contrast, when cooling the battery pack 2, the central region with a higher temperature than the outer circumferential region in each battery stack 11A to 11E is cooled prior to the outer circumferential region, so that each battery stack 11A to 11E and hence the battery pack 2 can be effectively cooled down.

### Second Embodiment

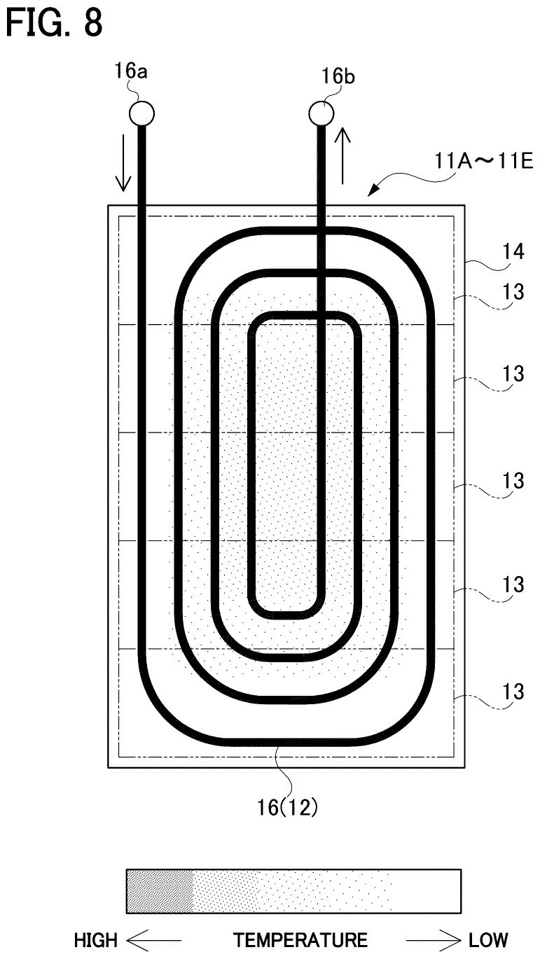

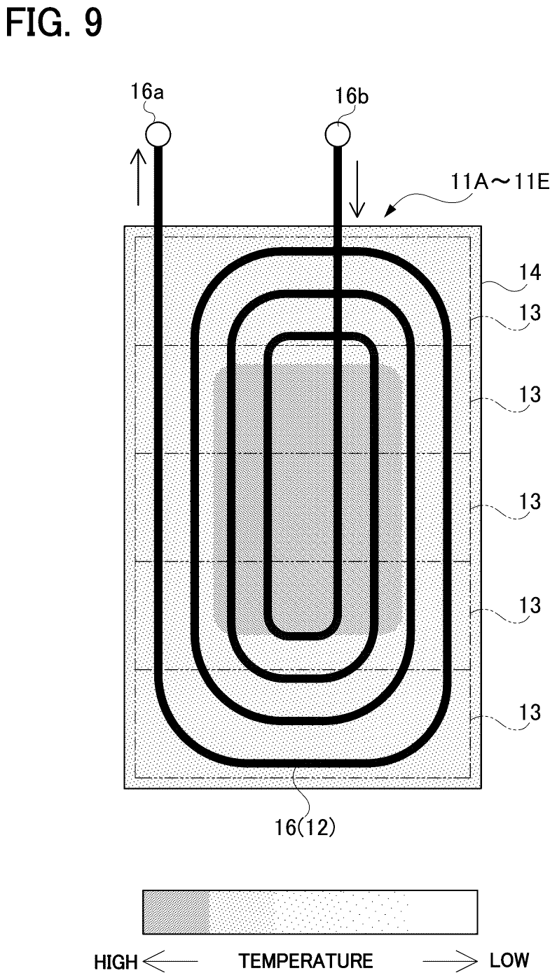

A second embodiment will be described below referring to FIGS. 8 and 9. The following description will be given with a focus on differences from the first embodiment, and similar or identical parts to those in the first embodiment are assigned the same reference sings and not described in detail.

### Structure of Heat-Exchange Pipe

This embodiment differs from the first embodiment in the configuration of the heat-exchange parts 12. FIGS. 8 and 9 are schematic diagrams showing each battery stack 11A to 11E. As shown in FIGS. 8 and 9, in the battery stacks 11A to 11E in the second embodiment, as in the first embodiment, the heat-exchange part 12 is constituted of the heat-exchange pipe 16 including the first input/output port 16a for heat medium at one end and the second input/output 16b for heat medium at the other end. This heat-exchange pipe 16 is arranged to extend from the first input/output port 16a, go around the outer circumferential region of each battery stack 11A to 11E, and further go spirally toward the center of each battery stack 11A to 11E, and finally reach the second input/output 16b. Specifically, the heat-exchange pipe 16 extending from the first input/output port 16a toward the inside of each battery stack 11A to 11E turns spirally from the outer circumferential region to gradually come close to the center of each battery stack 11A to 11E, and extends in a straight line from the central region to the second input/output 16b. The heat-exchange pipe 16 arranged in this pattern allows the heat medium to repeatedly flow in turn for the battery cells 13 arranged in a row and flow from the outer circumferential region gradually toward the central region of the battery cells 13 or gradually flow from the central region toward the outer circumferential region.

With the arrangement of the heat-exchange pipe 16 described above, the heat medium flowing in the heat-exchange pipe 16 through the first input/output port 16a flows through the outer circumferential region of each battery stack 11A to 11E, and then flows spirally from the outer circumferential region gradually toward the central region, and flows out from the central region at once through the second input/output 16b. At that time, in each battery cell 13, the heat medium flows through the outer circumferential region and then flows through the central region. In contrast, the heat medium flowing in the heat-exchange pipe 16 through the second input/output 16b flows through the central region of each battery stack 11A to 11E, and then flows spirally from the central region gradually toward the outer circumferential region, and flows out from the outer circumferential region at once through the first input/output port 16a. At that time, in each battery cell 13, the heat medium flows through the central region and then flows through the outer circumferential region.

### Operations and Effects of Battery Temperature Adjusting Device

The battery temperature adjusting device 1 configured as above in the second embodiment described above can achieve the same or similar operations and effects as those in the first embodiment, even though it is different in configuration of the heat-exchange pipes 16 (i.e., the heat-exchange parts 12) from the first embodiment.

### Third Embodiment

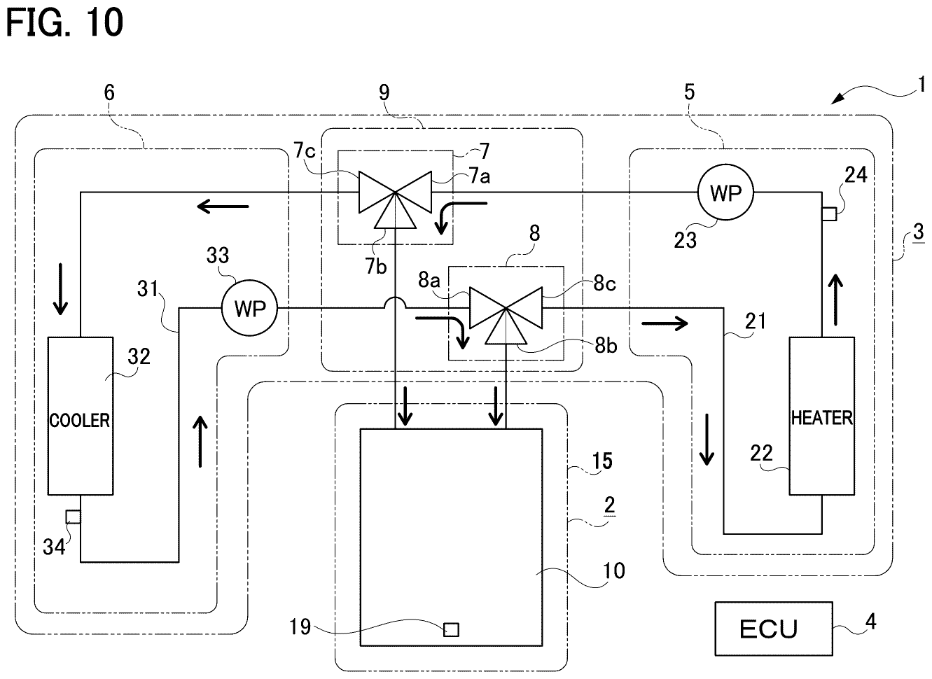

A third embodiment will be described blow referring to FIG. 10.

### Overview of Battery Temperature Adjusting Device

FIG. 10 is a schematic diagram showing a battery temperature adjusting device 1 in the third embodiment. This embodiment differs from each of the foregoing embodiments in the configuration of the battery pack 2. In the third embodiment, as shown in FIG. 10, the battery temperature adjusting device 1 is configured to flow the heat medium from the heat medium circuit 3 to only one battery 10. Here, this battery 10 may be a single battery element or a single battery stack constituted of a plurality of battery cells.

The battery temperature adjusting device 1 configured as above in the third embodiment can achieve the same or similar operations and effects as those in each of the foregoing embodiments, even though it is different in configuration of the battery pack 2 from each aforesaid embodiment.

### Fourth Embodiment

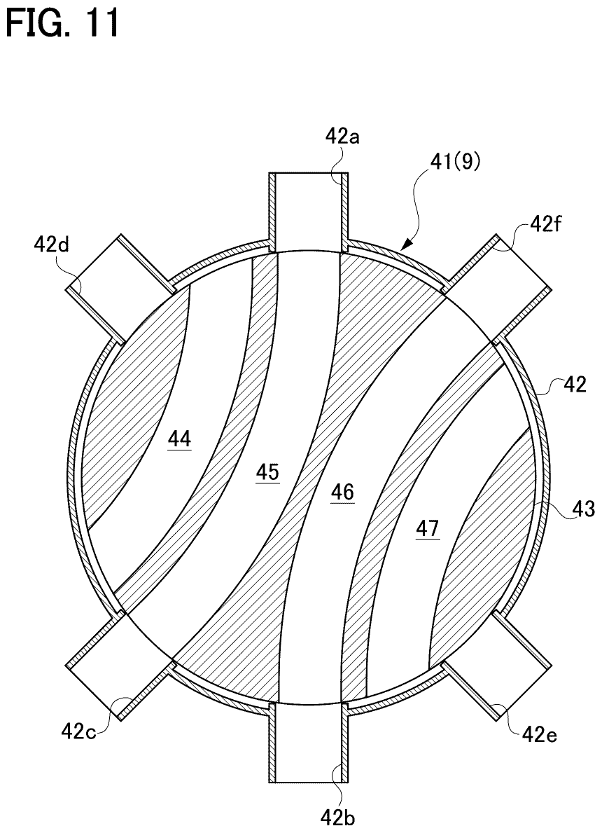

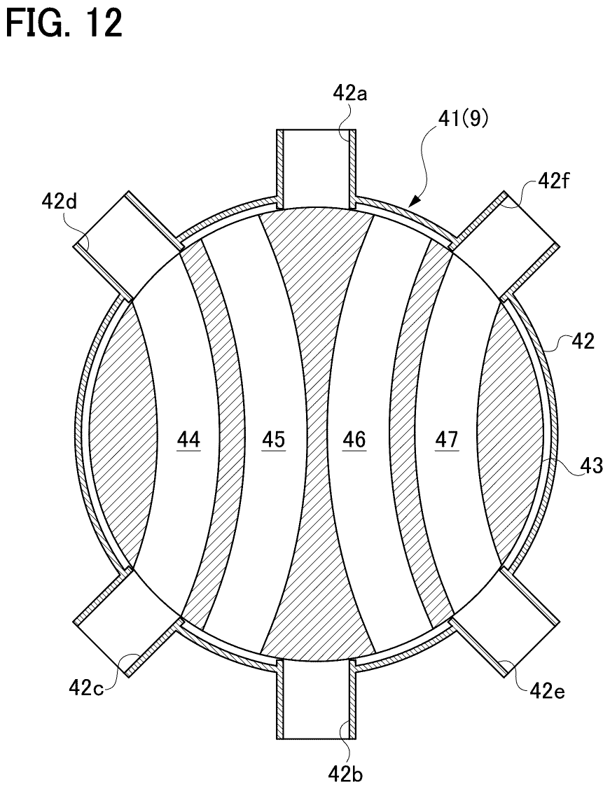

A fourth embodiment will be described below referring to FIGS. 11 and 12.

### Circuit Switching Unit

The fourth embodiment differs in the configuration of the circuit switching unit 9 from each of the foregoing embodiments. In the foregoing embodiments, the circuit switching unit 9 is constituted of two three-way valves 7 and 8. In the fourth embodiment, as another example, the circuit switching unit 9 is constituted of a single six-way valve 41. FIGS. 11 and 12 are cross-sectional views showing one example of the six-way valve 41. Specifically, FIG. 11 illustrates a switched position of the six-way valve 41 during a cooling request for the battery pack 2, and FIG. 12 illustrates a switched position of the six-way valve 41 during a warming request for the battery pack 2.

As shown in FIGS. 11 and 12, the six-way valve 41 is provided with a casing 42 having a circular shape in plan view, and a rotary body 43 having a circular shape in plan view and rotatably provided inside the casing 42. The rotary body 43 is driven to rotate by a motor, for example. This rotary body 43 is internally provided with four communication passages, concretely, a first communication passage 44, a second communication passage 45, a third communication passage 46, and a fourth communication passage 47, which have a nearly circular-arc shape in plan view and are arranged in parallel. Both ends of each communication passage 44 to 47 open on the outer periphery of the rotary body 43.

The casing 42 is provided, on its outer periphery, with six ports; a first port 42a, a second port 42b, a third port 42c, a fourth port 42d, a fifth port 42e, and a sixth port 42f, each extending radially. Here, the first port 42a corresponds to the first port 8a of the second three-way valve 8, the second port 42b corresponds to the third port 7c of the first three-way valve 7, the third port 42c corresponds to the second port 8b of the second three-way valve 8, the fourth port 42d corresponds to the third port 8c of the second three-way valve 8, the fifth port 42e corresponds to the first port 7a of the first three-way valve 7, and the sixth port 42f corresponds to the second port 7b of the first three-way valve 7.

Herein, the first and second ports 42a and 42b of the six-way valve 41 are connected to the cooling pipe 31 and the third port 42c is connected to the second common pipe 18 for the second input/output ports 16b. Further, the fourth and fifth ports 42d and 42e are connected to the warming pipe 21, and the sixth port 42f is connected to the first common pipe 17 for the first input/output ports 16a.

Accordingly, in response to a cooling request for the battery pack 2, the six-way valve 41 is switched to the position shown in FIG. 11, allowing the cooling medium to flow to the battery pack 2 as in FIG. 4. Alternatively, in response to a warming request for the battery pack 2, the six-way valve 41 is switched to the position shown in FIG. 12, allowing the warming medium to flow to the battery pack 2 as in FIG. 5.

### Operations and Effects of the Battery Temperature Adjusting Device

The battery temperature adjusting device 1 configured as above in the fourth embodiment described above can achieve the same or similar operations and effects as those in each of the foregoing embodiments, even though it is different in configuration of the circuit switching unit 9 from the foregoing embodiments. In addition, in the fourth embodiment, a flow of the heat medium to the battery pack 2 can be switched by the single six-way valve 41. Thus, the battery temperature adjusting device 1 in this embodiment can have a compact configuration as compared with the battery temperature adjusting device 1 provided with the two three-way valves 7 and 8 in each foregoing embodiment.

### Fifth Embodiment

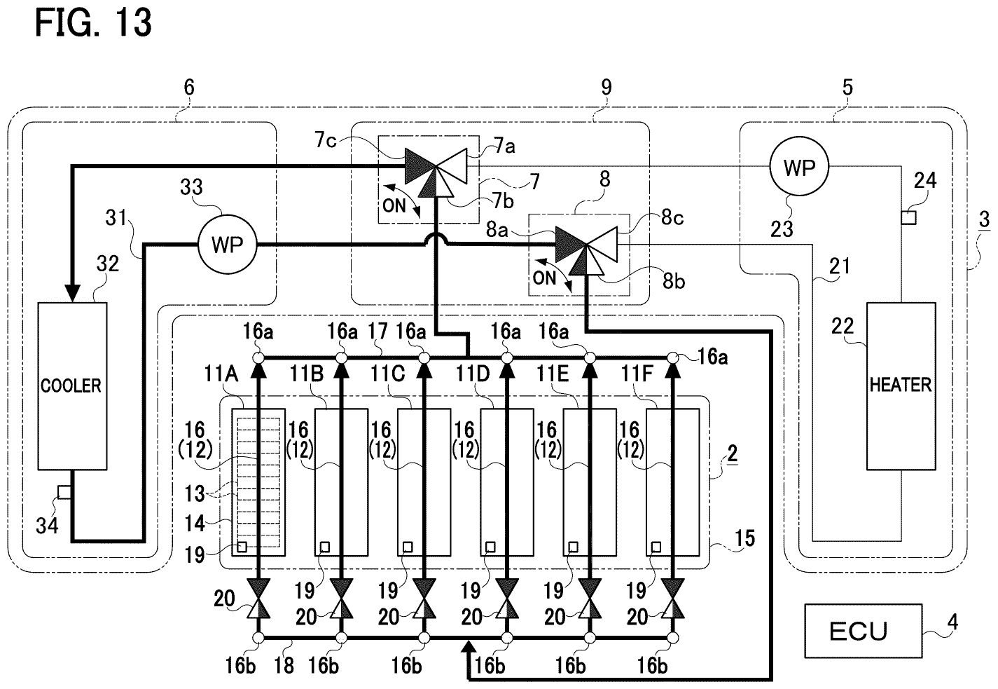

A fifth embodiment will be described blow referring to FIGS. 13 to 16.

For recent batteries, the following issues are considered: (1) long charging time, (2) battery deterioration due to temperature rise, and (3) high battery cost. Here, the issue (1) can be addressed by increasing the capacity of a battery for quick charging, i.e., increasing the amount of current. Regarding the issue (2), as trade-off with increased capacity, i.e., increased current amount, the battery temperature rises due to quick charging (high current), leading to the progress of battery deterioration. Therefore, in order to suppress the rise in battery temperature during quick charging of the battery, it is conceivable to change the manner of cooling the battery from an air-cooling type to a water-cooling type. However, a pump is essential for the water-cooling type. The output power required for the pump depends on the cooling performance during quick charging. The temperature of the battery (e.g., a battery cell and the like) during quick charging is higher in a region of the battery closer to the center. To efficiently suppress the temperature rise of the battery, it is necessary to reduce the battery maximum temperature and thus to efficiently equalize the temperatures of the batteries. Here, since the pump is demanded to output excessive power during running, it is desirable to adopt as small a pump as possible. Regarding the issue (3), it is possible to achieve cost reduction through product improvement and mass production.

In the present embodiment, therefore, the battery pack 2 including the battery stacks 11A to 11E and related configurations are configured, differently from the foregoing embodiments, to control the flow rate of the cooling medium allowed to flow to each of the battery stacks 11A to 11E according to the temperatures of the battery stacks 11A to 11E.

### Structure of Battery Temperature Adjusting Device

FIG. 13 is a schematic diagram showing the battery temperature adjusting device 1 in the fifth embodiment. The battery temperature adjusting device 1 shown in FIG. 13 differs from each of the foregoing embodiments in the battery pack 2 and related configurations thereto. As shown in FIG. 13, the battery pack 2 in this embodiment includes six battery stacks 11A to 11F. These battery stacks 11A to 11F are basically identical in configuration to those in the first embodiment, for example. However, in the fifth embodiment, the heat-exchange pipes 16, i.e., the heat-exchange parts 12, are arranged in parallel to a longitudinal direction of each battery stack 11A to 11F, i.e., in parallel to an arrangement direction of the battery cells 13 in each battery stack 11A to 11F. In each battery stack 11A to 11F, an electromagnetic valve 20 is provided just behind the second input/output 16b of the heat-exchange pipe 16, that is, on the inlet side for the cooling medium in each battery stack 11A to 11F. Those electromagnetic valves 20 are connected to the ECU 4 and controlled by the control for cooling a battery pack (hereinafter referred to as the “battery-pack cooling control”) which is executed by the ECU 4. In FIG. 13, the battery cells 13 constituting each of the battery stack 11A to 11F are illustrated only in the leftmost battery stack 11A and omitted in the other battery stacks 11B to 11F for convenience. The same applies to the following figures.

### Battery Pack Cooling Control

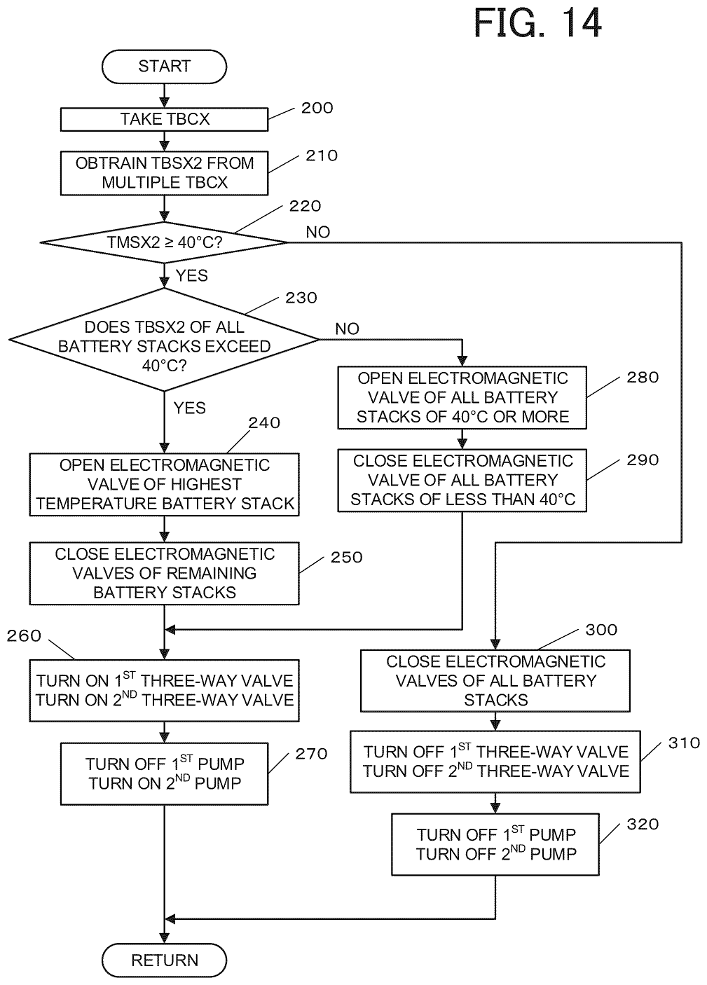

FIG. 14 is a flowchart showing one example of the battery-pack cooling control. When the process enters this routine, in step 200, the ECU 4 takes the battery cell temperature TBCX detected by the cell temperature sensor 19 of each battery cell 13 in each of the battery stacks 11A to 11F.

In next step 210, the ECU 4 obtains the temperature of each battery stack 11A to 11F, i.e., the battery stack temperature TBSX2, from among the multiple battery cell temperatures TBCX taken in step 200. The ECU 4 can obtain this battery stack temperature TBSX2 from the maximum temperature of the battery cell temperatures TBCX in each battery stack 11A to 11F.

In step 220, the ECU 4 determines whether or not the battery stack temperature TBSX2 is 40° C. or higher. When this determination result is affirmative (YES) in step 220, the ECU 4 proceeds to step 230. When this determination result is negative (NO) in step 220, the ECU 4 proceeds to step 300.

In step 230, the ECU 4 determines whether or not the battery stack temperatures TBSX2 of all the battery stacks 11A to 11F exceed 40° C. The ECU 4 proceeds to step 240 when YES in step 230 or to step 280 when NO in step 230.

In step 240, the ECU 4 opens the electromagnetic valve 20 of the highest-temperature one of the battery stacks 11A to 11F.

In step 250, the ECU 4 closes the electromagnetic valves 20 of remaining battery stacks 11A to 11F.

In step 260, the ECU 4 turns on the first three-way valve 7 and turns on the second three-way valve 8 to cool the battery pack 2.

In step 270, the ECU 4 turns off the first pump 23 and turns on the second pump 33. Then, the ECU 4 returns to step 200.

The state of the battery temperature adjusting device 1 in cooling the battery pack 2 is illustrated in the schematic diagram in FIG. 13. In this state, the cooling medium flowing from the cooling circuit 6 to the battery pack 2 flows in the heat-exchange pipe 16 through the second input/output port 16b in each of the battery stacks 11A to 11F, and flows out from the heat-exchange pipe 16 through the first input/output port 16a, as indicated by arrows in FIG. 13. This flowing direction of the cooling medium in the battery stacks 11A to 11F is indicated by the arrows in FIG. 13. However, FIG. 13 illustrates that the electromagnetic valves 20 of all the battery stacks 11A to 11F are open. In this case, the temperature is higher in a region of each battery stack 11A to 11F closer to the center thereof and thus the cooling medium flows through the central region of each battery stack 11A to 11F, which is high in temperature, thereby cooling the central region.

In step 280 following step 230, the ECU 4 opens the electromagnetic valves 20 of all the battery stacks having a temperature of 40° C. or higher from among the battery stacks 11A to 11F.

In step 290, the ECU 4 closes the electromagnetic valves 20 of all the battery stacks having a temperature of less than 40° C. from among the battery stacks 11A to 11F, and then proceeds to step 260.

In contrast, in step 300 following step 220, the ECU 4 closes the electromagnetic valves 20 of all the battery stacks 11A to 11F.

In step 310, the ECU 4 turns off the first three-way valve 7 and turns off the second three-way valve 8 to stop cooling of the battery pack 2.

In step 320, the ECU 4 turns off the first pump 23 and the turns off the second pump 33. Then, the ECU 4 returns to step 200.

### Operations and Effects of the Battery Temperature Adjusting Device

According to the battery temperature adjusting device 1 configured as above in the fifth embodiment described above, when a request for warming the battery pack 2 exists, that is, when the battery pack 2 needs to be warmed, the ECU 4 controls the circuit switching unit 9 to connect the heat-exchange parts 12 (i.e., the heat-exchange pipes 16) to the warming circuit 5 and further controls the electromagnetic valves 20. Thus, the heat-exchange pipes 16 are connected to the warming circuit 5, allowing the warming medium to flow in the heat-exchange pipes 16. In contrast, when a request for cooling the battery pack 2 exists, that is, when the battery pack 2 needs to be cooled, the ECU 4 controls the circuit switching unit 9 to connect the heat-exchange pipes 16 to the cooling circuit 6 and further controls the electromagnetic valves 20. Thus, the heat-exchange pipes 16 are connected to the cooling circuit 6, allowing the cooling medium to flow in the heat-exchange pipes 16. Accordingly, the ECU 4 controls the circuit switching unit 9 and simultaneously selectively controls the electromagnetic valves 20 to open, thereby selectively flowing the warming medium or the cooling medium to one or some of the heat-exchange pipes 16. This makes it possible to selectively warm or cool one or some of the battery stacks 11A to 11F, that is, a part of the battery pack 2 (the battery).

According to the configuration in the fifth embodiment, the electromagnetic valves 20 are provided individually in the heat-exchange pipes 16 of the battery stacks 11A to 11F constituting the battery pack 2. When cooling the battery pack 2, the electromagnetic valves 20 and others are controlled according to the temperatures of the corresponding battery stacks 11A to 11F to control a flow of the cooling medium with respect to each battery stack 11A to 11F. Specifically, according to the above-described battery-pack cooling control, only the electromagnetic valve(s) 20 corresponding to the high-temperature one(s) among the battery stacks 11A to 11F to control a flow of the cooling medium. Thus, the flow velocity of the cooling medium is accelerated in the heat-exchange pipe 16 of the high-temperature battery stack(s) among the battery stacks 11A to 11F, corresponding to the selectively opened electromagnetic valve(s) 20. This can enhance the cooling performance using the cooling medium in the high-temperature battery stacks 11A to 11F.

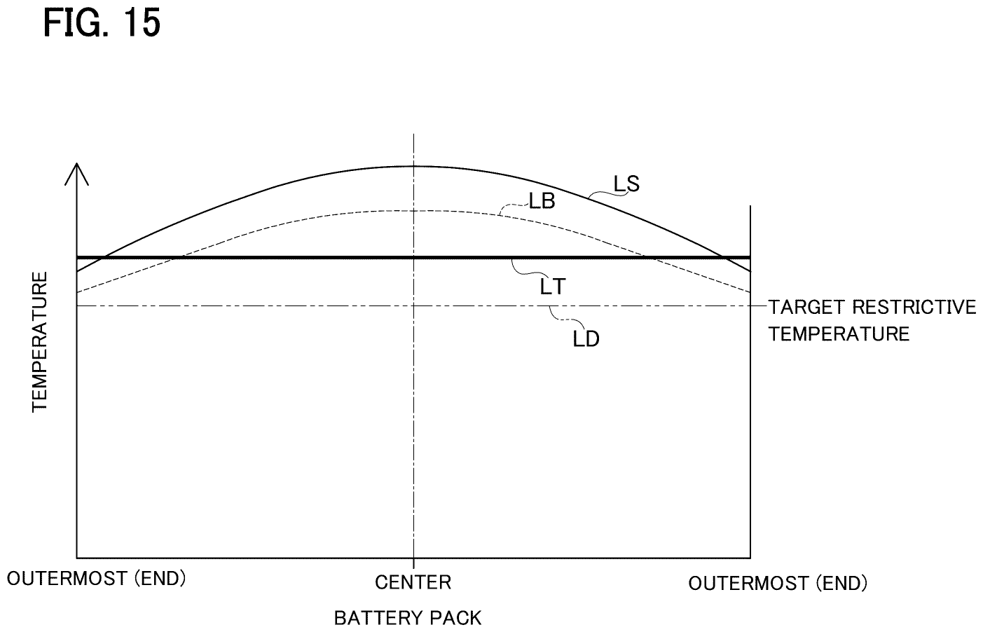

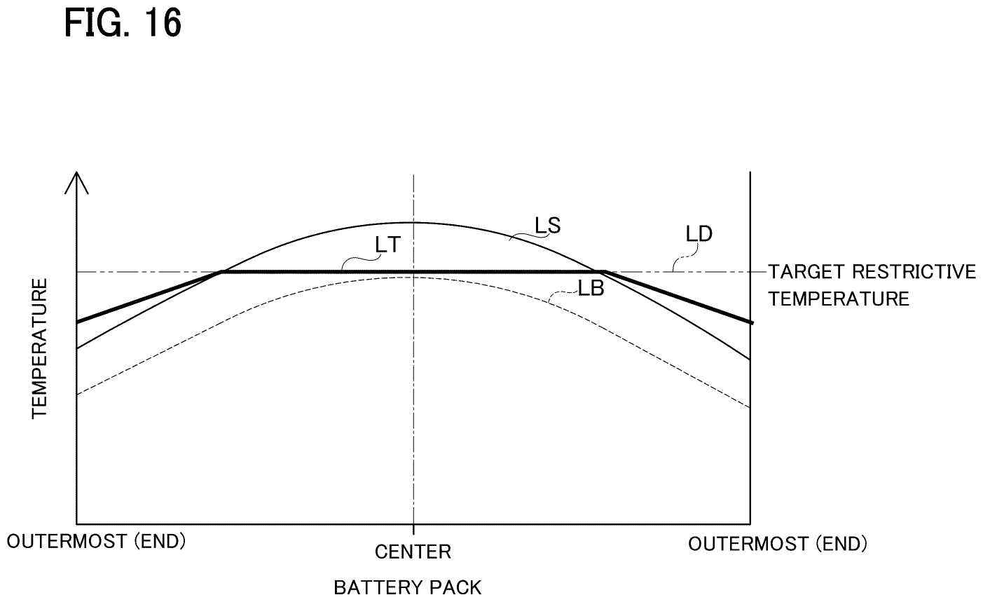

Herein, the results of temperature control on the battery pack 2 under the foregoing battery-pack cooling control are shown in graphs in FIGS. 15 and 16. In FIGS. 15 and 16, a solid line LS represents the temperature distribution when the flow rate control using the electromagnetic valve is not performed, a broken line LB represents a temperature distribution in a conventional art, a two-dot chain line LD represents a target restrictive temperature, and a thick line LT represents a temperature distribution in the present embodiment. Specifically, FIG. 15 shows the results of temperature control on the battery pack 2 under the control in step 240 to step 270 in FIG. 14. According to the above-described battery-pack cooling control, as revealed from FIG. 15, the temperature of the battery pack 2 is higher than the target restrictive temperature, but lower than the case with no flow rate control and the conventional case, and thus the temperatures over the entire regions, from the outermost regions (both ends) to the central region, of the battery pack 2 could be made uniform. FIG. 16 shows the results of temperature control on the battery pack 2 under the control in steps 280, 290, 260, and 270 in FIG. 14. According to the above-described battery-pack cooling control, as revealed from FIG. 16, the temperature of the battery pack 2, near the outermost regions (both ends) of the battery pack 2, is lower than the target restrictive temperature, and thus the temperature of the central region of the battery pack 2 could be controlled to the target restrictive temperature.

### Sixth Embodiment

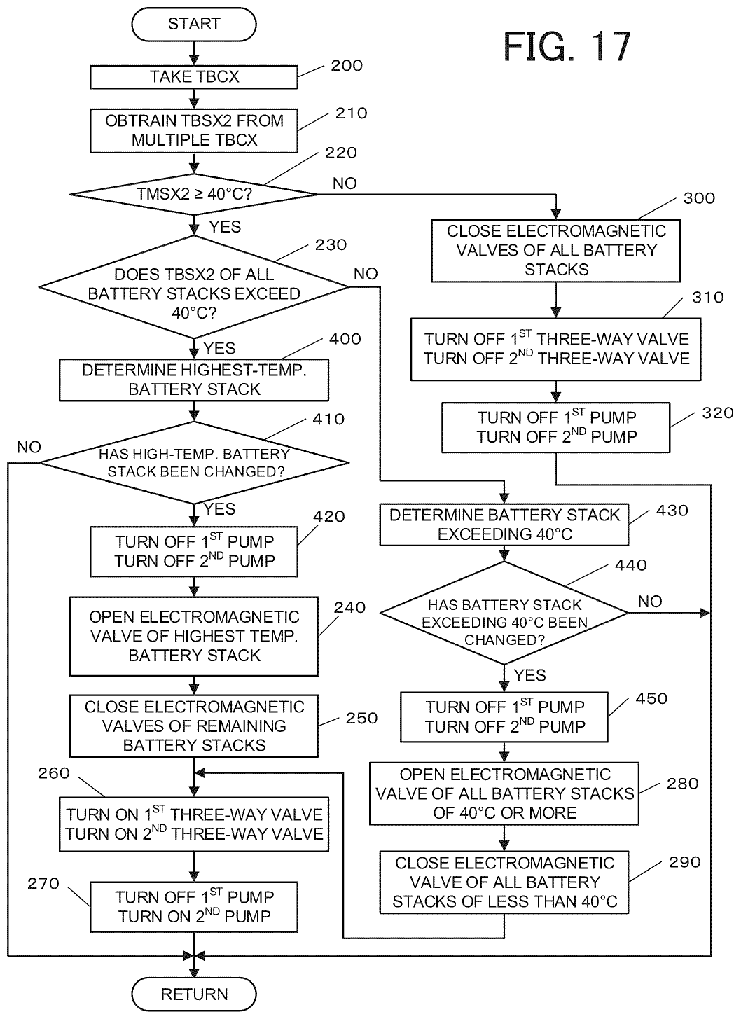

A sixth embodiment will be described blow referring to FIG. 17.

### Battery Pack Cooling Control

The sixth embodiment differs from the fifth embodiment in the contents of the battery-pack cooling control. FIG. 17 is a flowchart showing one example of the contents of the battery-pack cooling control in the present embodiment. In the flowchart in FIG. 17, different in the contents from that in FIG. 14, the process in step 400 to step 420 are added between step 230 and step 240, and step 430 to step 450 are added between step 230 and step 280.

When the process enters this routine, the ECU 4 executes the process in step 200 to step 230, and proceeds to step 400 when YES in step 230 or instead to step 430 when NO in step 230.

In step 400, the ECU 4 determines the highest-temperature one of the battery stacks 11A to 11F.

In next step 410, the ECU 4 determines whether or not the highest-temperature one of the battery stacks 11A to 11F has been changed to another.

The ECU 4 proceeds to step 420 when YES in step 410 or returns to step 200 when NO in step 410.

In step 420, the ECU 4 turns off the first pump 23 and turns off the second pump 33.

The ECU 4 executes the process in step 240 to step 270 and then returns to step 200.

In contrast, in step 430 following step 230, the ECU 4 determines the battery stack(s) exceeds 40° C. from among the battery stacks 11A to 11F.

In step 440, the ECU 4 determines whether or not the battery stack(s) with a temperature exceeding 40° C. among the battery stacks 11A to 11F has been changed to another. The ECU 4 proceeds to step 450 when YES in step 440 or returns to step 200 when NO in step 440.

In step 450, the ECU 4 turns off the first pump 23 and turns off the second pump 33.

The ECU 4 thereafter executes the process in steps 280, 290, 260, and 270, and returns to step 200.

### Operations and Effects of the Battery Temperature Adjusting Device

According to the battery temperature adjusting device 1 configured as above in the sixth embodiment described above, in the foregoing battery-pack cooling control, when opening the corresponding electromagnetic valves 20 to cool the high-temperature battery stack(s) among the battery stacks 11A to 11F, the ECU 4 stops each of the first pump 23 and the second pump 33 before opening the corresponding electromagnetic valves 20, different from the fifth embodiment. Consequently, a pressure difference of the cooling medium between the inlet and the outlet of the corresponding electromagnetic valve 20, namely, a valve front-rear differential pressure, decreases. Accordingly, a coil used in the electromagnetic valves 20 can be reduced in size, leading to cost reduction of the electromagnetic valves 20.

### Seventh Embodiment

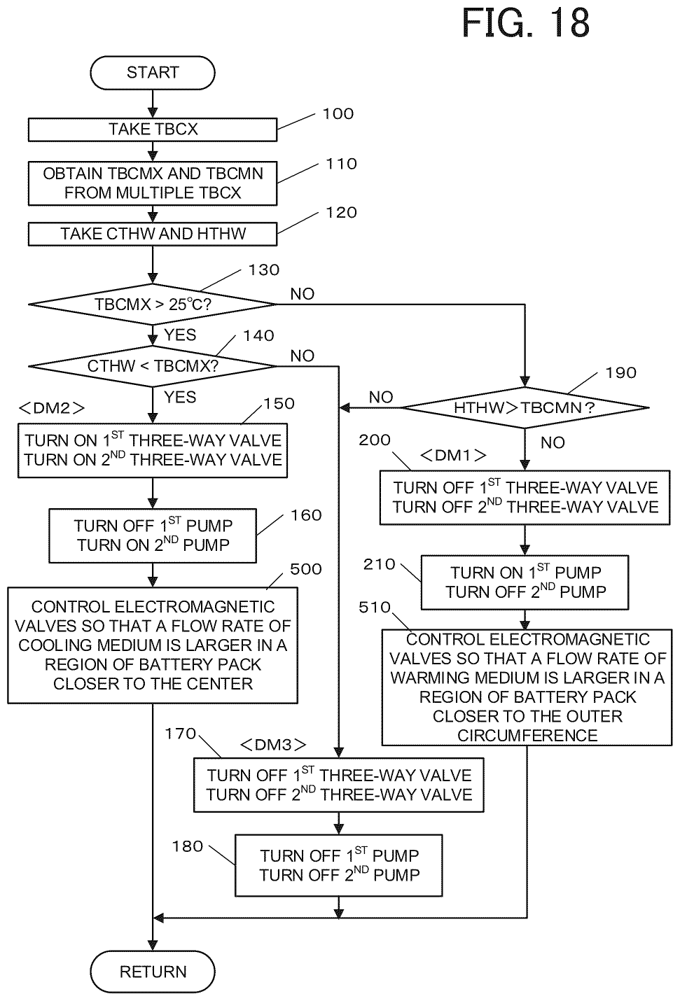

A seventh embodiment will be described blow referring to FIG. 18.

### Battery-Pack Warming-Cooling Control

In the seventh embodiment, assuming that the system configuration shown in FIG. 13 as in the fifth and sixth embodiments is provided, the control of warming and cooling the battery pack (hereinafter, referred to as battery-pack warming-cooling control) is executed instead of the battery-pack cooling control. FIG. 18 is a flowchart showing one example of contents of the battery-pack warming-cooling control in the seventh embodiment. The flowchart in FIG. 18 differs from the flowchart in FIG. 3 described in the first embodiment in that step 500 is added after step 160 and step 510 is added after step 210 in the flowchart in FIG. 3.

When the process enters this routine in FIG. 18, the ECU 4 executes the process in step 160 to cool the battery pack 2 and then, in step 500, controls the electromagnetic valves 20 so that the flow rate of cooling medium is higher in the central region of the battery pack 2 than other regions thereof. For example, in FIG. 13, the electromagnetic valves 20 corresponding to the battery stacks 11A, 11B, 11E, and 11F located on right and left outer circumferential regions of the battery pack 2 are turned off, i.e., closed, while only the electromagnetic valves 20 corresponding to the battery stacks 11C and 11D located on the central region of the battery pack 2 are turned on, i.e., opened. Then, the ECU 4 returns to step 100.

In contrast, after executing the process in step 210 to warm the battery pack 2, the ECU 4 controls, in step 510, the electromagnetic valves 20 so that the flow rate of warming medium is higher in the outer circumferential region of the battery pack 2 than other regions thereof. For example, in FIG. 13, only the electromagnetic valves 20 corresponding to the battery stacks 11A, 11B, 11E, and 11F located on the right and left outer circumferential regions of the battery pack 2 are turned on, i.e., opened, while the electromagnetic valves 20 corresponding to the battery stacks 11C and 11D located on the central region of the battery pack 2 are turned off, i.e., closed. Thereafter, the ECU 4 returns to step 100.

### Operations and Effects of the Battery Temperature Adjusting Device

According to the battery temperature adjusting device 1 configured as above in the seventh embodiment described above, when a warming request for the battery pack 2 exists, that is, when the battery pack 2 needs to be warmed, that is, it is preferable to warm the battery pack 2 from the outer circumferential region with a lower temperature than the central region. When a cooling request for the battery pack 2 exists, that is, when the battery pack 2 needs to be cooled, it is preferable to cool the battery pack 2 from the central region with a higher temperature than the outer circumferential region. According to the above-described configuration, the heat-exchange parts 12 (the heat-exchange pipes 16) are arranged to flow the cooling medium at a higher flow rate through the central region than the outer circumferential region in order to cool the battery pack 2, so that a high flow rate of cooling medium flows through the central region of the battery pack 2. In contrast, the heat-exchange pipes 16 are arranged to flow the warming medium at a higher flow rate through the outer circumferential region than the central region in order to warm the battery pack 2, so that a high flow rate of warming medium flows through the outer circumferential region of the battery pack 2. This arrangement enables to effectively cool the central region of the battery pack 2 (the battery) in cooling the battery pack 2 and to effectively warm the outer circumferential region of the battery pack 2 in warming the battery pack 2.

### Eighth Embodiment

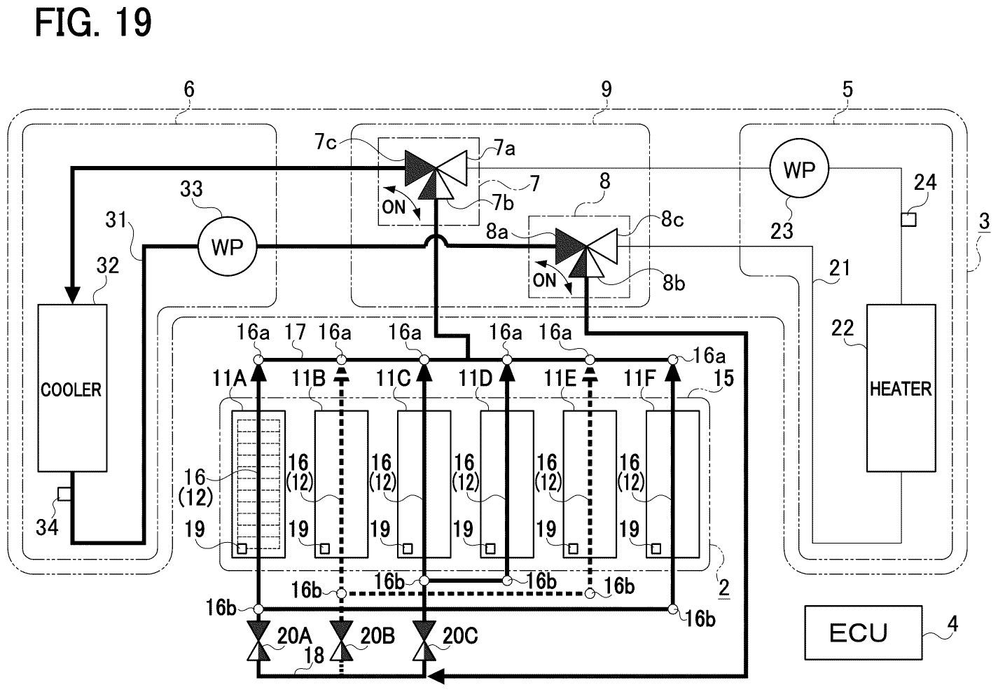

An eighth embodiment will be described below referring to FIG. 19.

### Structure of Battery Temperature Adjusting Device

This eighth embodiment differs from the fifth to seventh embodiments in the arrangement of the heat-exchange pipes 16 and the electromagnetic valves 20 in the battery pack 2. FIG. 19 is a schematic diagram showing the battery temperature adjusting device 1 in the eighth embodiment. In this embodiment, as shown in FIG. 19, for six battery stacks 11A to 11F, three electromagnetic valves, that is, a first electromagnetic valve 20A, a second electromagnetic valve 20B, and a third electromagnetic valve 20C are provided just before the second input/output ports 16b of the corresponding heat-exchange pipes 16, that is on the inlet side of the cooling medium in the battery stacks 11A to 11F, as shown in FIG. 19. The first electromagnetic valve 20A is placed corresponding to the heat-exchange pipes 16 of two battery stacks 11A and 11F located at both ends, among the six battery stacks 11A to 11F arranged in parallel. The second electromagnetic valve 20B is placed corresponding to the heat-exchange pipes 16 of two battery stacks 11B and 11E respectively adjacent to the two endmost battery stacks 11A and 11F. The third electromagnetic valve 20C is placed corresponding to the heat-exchange pipes 16 of two battery stacks 11C and 11D located in the central region. Those electromagnetic valves 20A to 20C are connected to the ECU 4 and controlled under the battery-pack cooling control and the battery-pack warming-cooling control which are executed by the ECU 4. In the present embodiment, specifically, the arrangement area of the battery stacks 11A to 11F is divided into right and left end areas, more inside areas than the end areas, and a central area. The electromagnetic valves 20A to 20C are provided, one for each two of the battery stacks 11A to 11F in each area, to control a flow of cooling medium and a flow of warming medium for the battery stacks 11A to 11C in each area.

### Operations and Effects of the Battery Temperature Adjusting Device

According to the battery temperature adjusting device 1 configured as above in the eighth embodiment described above, different from the sixth and seventh embodiments, the battery pack 2 constituted of six battery stacks 11A to 11F is divided into three areas, that is, the outermost area for the rightmost battery stack 11A and the leftmost battery stack 11F, the second outermost area for the battery stacks 11B and 11E more inside than the battery stacks 11A and 11F, and the central area for the battery stacks 11C and 11D, and three electromagnetic valves 20A to 20C are provided one for each of those three areas to control the cooling medium and the warming medium to flow in each area. Thus, the present embodiment can control a flow of the cooling medium and a flow of the warming medium in each area by use of the electromagnetic valves 20A to 20C, fewer than the number of the battery stacks 11A to 11F. Therefore, the battery temperature adjusting device 1 can be simplified in structure and reduced in size by the reduced number of electromagnetic valves 20A to 20C.

### Ninth Embodiment

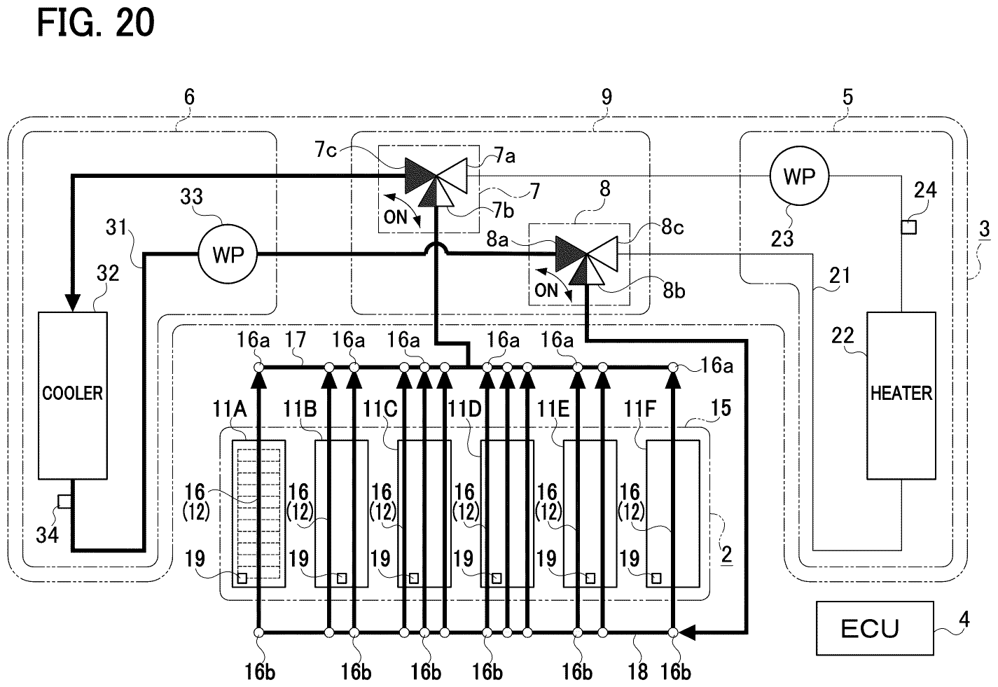

A ninth embodiment will be described below referring to FIG. 20.

### Structure of Battery Temperature Adjusting Device

The ninth embodiment differs from each of the foregoing embodiments in the configuration of the heat-exchange pipes 16 in the battery pack 2. FIG. 20 is a schematic diagram showing the battery temperature adjusting device 1 in the present embodiment. Here, during quick charging of the battery pack 2, the temperatures of the battery cells 13 and the battery stacks 11A to 11F tend to be higher in the arrangement areas closer to the center. In the present embodiment, therefore, the heat-exchange pipes 16 are arranged to improve the cooling performance of the central region of the battery pack 2, that is, the battery stacks 11B to 11E placed in the areas closer to the center in the arrangement direction of the battery stacks 11A to 11F, among the battery stacks 11A to 11F. In the present embodiment, specifically, one heat-exchange pipe 16 is placed for each of two battery stacks 11A and 11F located at both ends, among the six battery stacks 11A to 11F arranged in parallel, two heat-exchange pipes 16 are placed for each of two battery stacks 11B and 11E located respectively adjacent to the battery stacks 11A and 11F, and three heat-exchange pipes 16 are placed for each of two battery stacks 11C and 11D located in the central area, as shown in FIG. 20. In other words, in the present embodiment, the number of heat-exchange pipes 16 is larger for the battery stacks 11B to 11E placed in the areas closer to the center, among the six battery stacks 11A to 11F arranged in parallel, thereby increasing the total surface area of pipe passage walls, so that a flow rate of cooling medium and warming medium is different for each area.

### Operations and Effects of the Battery Temperature Adjusting Device

According to the battery temperature adjusting device 1 configured as above in the ninth embodiment, among the six battery stacks 11A to 11F arranged in parallel, the battery stacks 11B to 11E in the areas closer to the center in the arrangement direction of the battery stacks 11A to 11F are provided with more heat-exchange pipes 16 to increase the total surface area of pipe passage walls. With this configuration, a flow rate of cooling medium and a flow rate of warming medium can be different for arrangement area of the battery stacks 11A to 11F. Furthermore, the battery temperature adjusting device 1 can be simplified in structure and reduced in size due to the absence of an electromagnetic valve and others.

### Tenth Embodiment

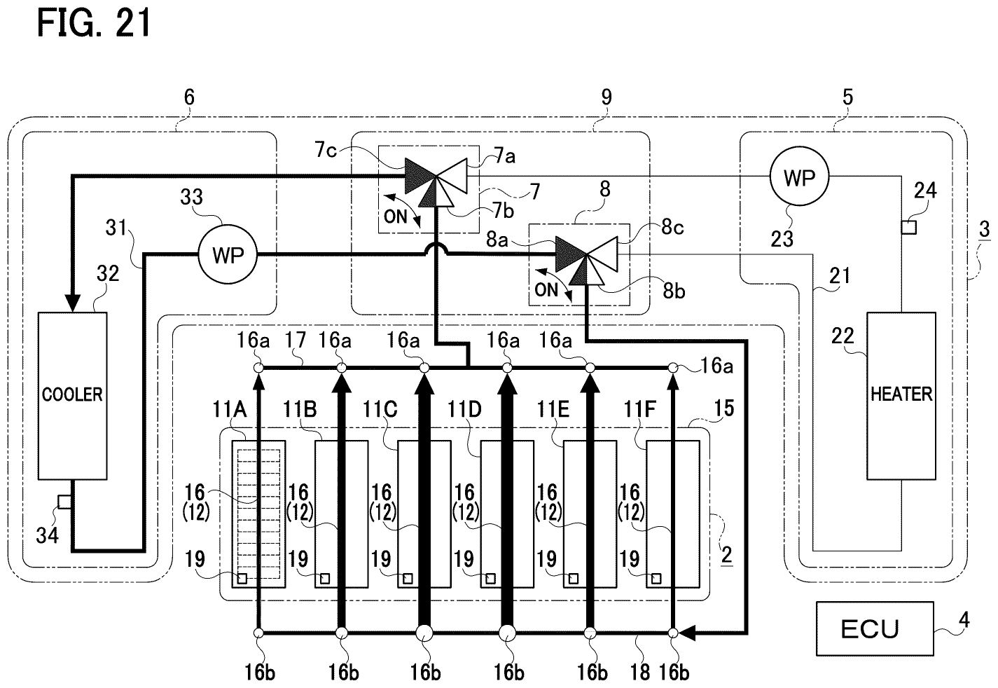

A tenth embodiment will be described below referring to FIG. 21.

### Structure of Battery Temperature Adjusting Device

The tenth embodiment differs from the ninth embodiment in the configuration of the heat-exchange pipes 16 in the battery pack 2. FIG. 21 is a schematic diagram showing the battery temperature adjusting device 1 in the present embodiment. The foregoing ninth embodiment exemplifies that, the number of heat-exchange pipes 16 is set larger for the battery stacks 11B to 11E in the areas closer to the center in the arrangement direction of the battery stacks 11A to 11F, among the six battery stacks 11A to 11F arranged in parallel, in order to increase the total surface area of pipe passage walls. In contrast, in the tenth embodiment, as shown in FIG. 21, the outer diameters of the heat-exchange pipes 16 each having circular cross-section are set larger for the battery stacks 11B to 11E in the areas closer to the center among six battery stacks 11A to 11F arranged in parallel, in order to increase the total surface area of pipe passage walls. In the present embodiment, specifically, a heat-exchange pipe 16 having a small outer diameter is placed for each of two battery stacks 11A and 11F located at both ends, among the six battery stacks 11A to 11F, a heat-exchange pipe 16 having a second thick outer diameter is placed for each of two battery stacks 11B and 11E located respectively adjacent to the battery stacks 11A and 11F, and a heat-exchange pipe 16 having a thickest outer diameter is placed for each of two battery stacks 11C and 11D located in the central area, as shown in FIG. 21.

### Operations and Effects of the Battery Temperature Adjusting Device

According to the battery temperature adjusting device 1 configured as above in the present embodiment, the passage areas of the heat-exchange pipes 16 are set larger for the battery stacks 11B to 11E located in the areas closer to the center in the arrangement direction of the battery stacks 11A to 11F, so that the cooling medium flowing through those heat-exchange pipes 16 has a lower pressure drop, allowing the flow rate of that cooling medium to increase. With this configuration, a flow rate of cooling medium and a flow rate of warming medium can be different for each arrangement area of the battery stacks 11A to 11F. Furthermore, the battery temperature adjusting device 1 can be simplified in structure and reduced in size due to the absence of an electromagnetic valve and others.

### Eleventh Embodiment

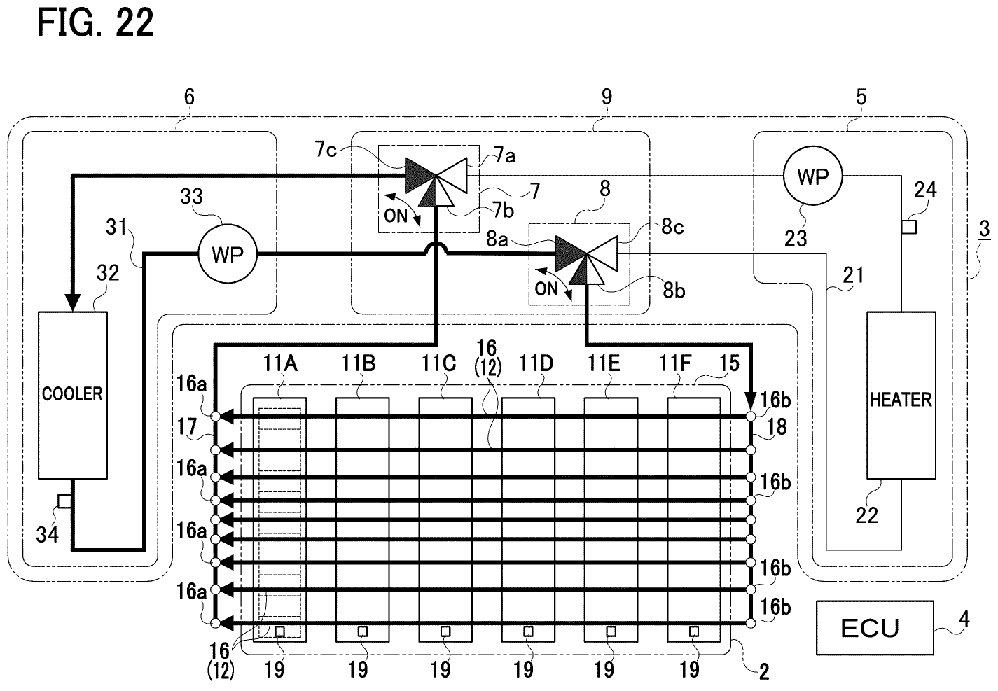

An eleventh embodiment will be described below referring to FIG. 22.

### Structure of Battery Temperature Adjusting Device

The eleventh embodiment differs from each of the foregoing embodiments in the configuration of the heat-exchange pipes 16 in the battery pack 2. FIG. 22 is a schematic diagram showing the battery temperature adjusting device 1 in this embodiment. In the above-described fifth to tenth embodiments, for the battery stacks 11A to 11F arranged in parallel, the heat-exchange pipes 16 are placed along the longitudinal direction of each battery stack 11A to 11F, that is, in the arrangement direction of the battery cells 13. Of the battery stacks 11A to 11F, for the battery stacks 11B to 11E located in the areas closer to the center in the arrangement direction of the battery stacks 11A to 11F are provided with more heat-exchange pipes 16 or a heat-exchange pipe 16 having a larger outer diameter to increase the total surface area of pipe passage walls. In contrast, in the eleventh embodiment, as shown in FIG. 22, for the battery stacks 11A to 11F arranged in parallel, the heat-exchange pipes 16 are placed in parallel in a direction perpendicular to the longitudinal direction of the battery stacks 11A to 11F, and the heat-exchange pipes 16 are placed with smaller intervals at positions closer to the center in the longitudinal direction of the battery stacks 11A to 11F to increase the number of heat-exchange pipes 16.

### Operations and Effects of the Battery Temperature Adjusting Device

According to the battery temperature adjusting device 1 configured as above in the present embodiment, for the battery stacks 11A to 11F arranged in parallel, the heat-exchange pipes 16 are placed at smaller intervals at positions closer to the center in the longitudinal direction of each battery stack 11A to 11F to increase the number of heat-exchange pipes 16 in order to increase the total surface area of pipe passage walls. With this configuration, a flow rate of cooling medium and a flow rate of warming medium can be different for each area in the longitudinal direction of the battery stacks 11A to 11F. In addition, the battery temperature adjusting device 1 can be simplified in structure and reduced in size due to the absence of an electromagnetic valve and others.

### Twelfth Embodiment

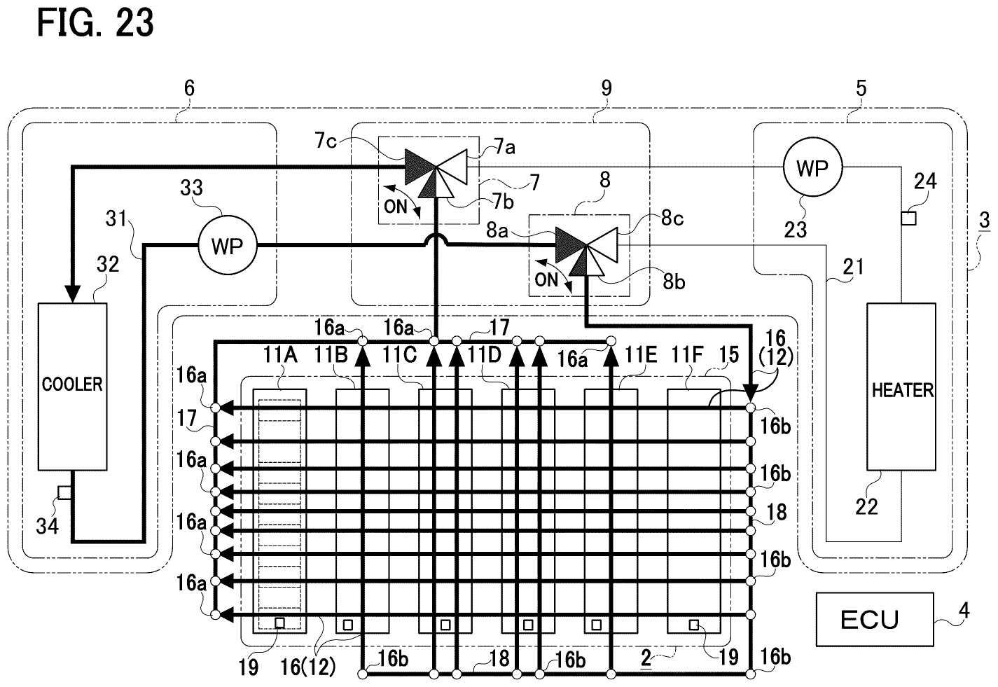

A twelfth embodiment will be described below referring to FIG. 23.

### Structure of Battery Temperature Adjusting Device

The twelfth embodiment differs from the eleventh embodiment in the configuration of the heat-exchange pipes 16 in the battery pack 2. FIG. 23 is a schematic diagram of the battery temperature adjusting device 1 in this embodiment. In the foregoing eleventh embodiment, for the battery stacks 11A to 11F arranged in parallel, the heat-exchange pipes 16 are placed in parallel to the direction perpendicular to the longitudinal direction of each battery stack 11A to 11F, and the heat-exchange pipes 16 are arranged at smaller intervals at positions closer to the center in the longitudinal direction of the battery stacks 11A to 11F to increase the number of heat-exchange pipes 16. In contrast, in the present embodiment, as shown in FIG. 23, in addition to the configuration of the eleventh embodiment, heat-exchange pipes 16 are further arranged in parallel to the longitudinal direction of the battery stacks 11A to 11F arranged in parallel so that the number of heat-exchange pipes 16 is larger for the battery stacks 11B to 11E located in or closer to the central area. In other words, among the battery stacks 11A to 11F, the battery stacks 11A and 11F located at both ends in the parallel arrangement are not provided with the heat-exchange pipe 16 parallel to the longitudinal direction of each battery stack 11A and 11F, the battery stacks 11B and 11E located respectively adjacent to the battery stacks 11A and 11F are each provided with one heat-exchange pipe 16 parallel to the longitudinal direction of each battery stack 11B and 11E, and the battery stacks 11C and 11D located in the center are each provided with two heat-exchange pipes 16 parallel to the longitudinal direction of each battery stack 11C and 11D.

### Operations and Effects of the Battery Temperature Adjusting Device

According to the battery temperature adjusting device 1 configured as above in the present embodiment, in addition to the configuration of the eleventh embodiment, for the parallel battery stacks 11A to 11F, the heat-exchange pipes 16 are additionally arranged in parallel to the longitudinal direction of each battery stack 11A to 11F to increase the number of heat-exchange pipes 16 for the battery stacks 11B to 11E in or close to the central area. With this configuration, a flow rate of cooling medium and a flow rate of warming medium can be increased in or close to the central area of the battery pack 2 including the battery stacks 11A to 11F. In addition, the battery temperature adjusting device 1 can be simplified in structure and reduced in size due to the absence of an electromagnetic valve and others.

### Thirteenth Embodiment

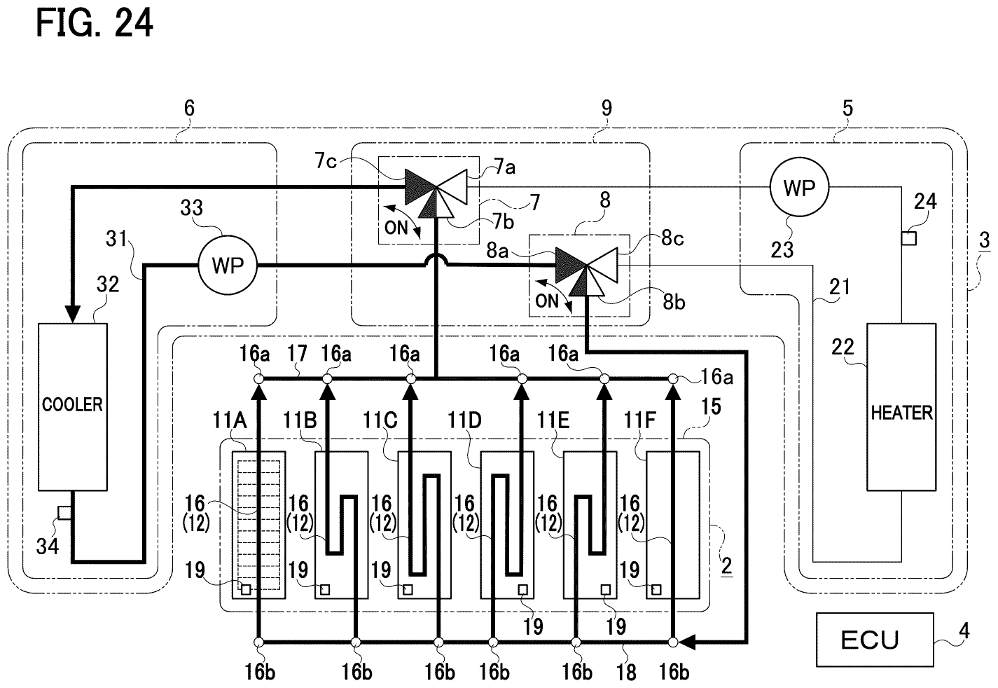

A thirteenth embodiment will be described below referring to FIG. 24.

### Structure of Battery Temperature Adjusting Device

The thirteenth embodiment differs from the ninth embodiment in the configuration of the heat-exchange pipes 16 in the battery pack 2. FIG. 24 is a schematic diagram showing the battery temperature adjusting device 1 in this embodiment. In the foregoing ninth embodiment, the heat-exchange pipes 16 are placed simply in parallel to the longitudinal direction of the battery stacks 11A to 11F arranged in parallel, and the heat-exchange pipes 16 are arranged at smaller intervals at positions closer to the center of the arrangement area to increase the number of heat-exchange pipes 16. In contrast, in the thirteenth embodiment, as shown in FIG. 24, the heat-exchange pipes 16 each have a longer length for the battery stacks 11B to 11E in the area closer to the center in the arrangement direction of the battery stacks 11A to 11F, among the battery stacks 11A to 11F, and further those heat-exchange pipes 16 are arranged in a zigzag pattern in the central region in each battery stack 11B to 11E.

### Operations and Effects of the Battery Temperature Adjusting Device

According to the battery temperature adjusting device 1 configured as above in the present embodiment, among the battery stacks 11A to 11F arranged in parallel, the battery stacks 11B to 11E in the areas closer to the center are provided with the heat-exchange pipes 16 with longer length and larger distribution to increase the total surface area of pipe passage wall. With this configuration, a flow rate of cooling medium and a flow rate of warming medium can be different for each arrangement area of the battery stacks 11A to 11F. In addition, the battery temperature adjusting device 1 can be simplified in structure and reduced in size due to the absence of an electromagnetic valve and others.

The foregoing embodiments are mere examples and give no limitation to the present disclosure. The present disclosure may be embodied in other specific forms without departing from the essential characteristics thereof.

(1) In the foregoing fifth and eighth embodiments, for the battery stacks 11A to 11F constituting the battery pack 2, the electromagnetic valves 20, and 20A to are provided just behind the second input/outputs 16b of the heat-exchange pipes 16, that is, on the inlet side of the cooling medium in the battery stacks 11A to 11F. As an alternative, in battery stacks of a battery pack, electromagnetic valves may be provided just behind first input/output ports of heat-exchange pipes, that is, on an outlet side of the cooling medium in the battery stacks. In this case, the front-rear differential pressure of each electromagnetic valve is lower than the above configuration, so that a coil of each electromagnetic valve can be reduced in size and hence the electromagnetic valve can be reduced in size.

(2) In the foregoing tenth embodiment, the heat-exchange pipes 16 each having a circular cross-section have a larger outer diameter for the battery stacks 11A to 11F located close to the central area, among the six battery stacks 11A to 11F arranged in parallel, in order to increase the total surface area of pipe passage walls. As an alternative, for the battery stacks 11A to 11F located in the areas closer to the center, heat-exchange pipes may have an elliptic cross-sectional shape with a longer major axis to increase the outer circumferential length per equal cross-sectional area.

(3) In the foregoing ninth to thirteenth embodiments, the heat-exchange pipes 16 (i.e., the heat-exchange parts 12) are not provided with any electromagnetic valve, but alternatively the heat-exchange pipes (i.e., heat-exchange parts) may be individually provided with electromagnetic valves. In this case, when one or some of the electromagnetic valves are selectively opened, allowing the cooling medium or warming medium to flow to only the battery stack(s) located in a specified area(s) among the battery stacks arranged in parallel.

The present disclosure is utilizable for adjustment of the temperature of a secondary battery which is mounted in an electric vehicle.

### REFERENCE SIGNS LIST

1 Battery temperature adjusting device
2 Battery pack (Battery)
3 Heat medium circuit
4 ECU (Control unit)
5 Warming circuit
6 Cooling circuit
7 First three-way valve (Circuit switching unit)
8 Second three-way valve (Circuit switching unit)
9 Circuit switching unit
10 Battery
11A-11F Battery stack (Battery)
12 Heat-exchange part
13 Battery cell
14 Case
16 Heat-exchange pipe (Heat-exchange part)
16a First input/output port
16b Second input/output
20 Electromagnetic valve
20A First electromagnetic valve
20B Second electromagnetic valve
20C Third electromagnetic valve
41 Six-way valve (Circuit switching unit)

What is claimed is:

1. A battery temperature adjusting device comprising:
a battery;
a heat-exchange part configured to exchange heat between the battery and a heat medium; and
a heat medium circuit configured to flow the heat medium to the heat-exchange part,
the battery temperature adjusting device being configured to adjust a temperature of the battery by flowing the heat medium to the heat-exchange part through the heat medium circuit to exchange heat with the battery,
wherein the heat medium circuit includes:
a warming circuit configured to flow the heat medium with a raised temperature to the heat-exchange part to warm the battery; and
a cooling circuit configured to flow the heat medium cooled to the heat-exchange part to cool the battery, and
the battery temperature adjusting device further comprises a circuit switching unit configured to switch between the warming circuit and the cooling circuit to connect the warming circuit to the heat-exchange part when warming the battery and to connect the cooling circuit to the heat-exchange part when cooling the battery.

2. The battery temperature adjusting device according to claim 1, wherein
the battery is constituted of a plurality of battery stacks each including a plurality of battery cells and a case accommodating the battery cells, and
the heat-exchange part is arranged to flow the heat medium to each of the battery stacks.

3. The battery temperature adjusting device according to claim 1, wherein
the heat-exchange part includes a heat-exchange pipe having a first input/output port for the heat medium at one end and a second input/output port for the heat medium at the other end, and
the heat-exchange pipe is arranged to extend from the first input/output port, go through an outer circumferential region of the battery, and further through a central region of the battery, and then reach the second input/output port.

4. The battery temperature adjusting device according to claim 2, wherein
the heat-exchange part includes a heat-exchange pipe having a first input/output port for the heat medium at one end and a second input/output port for the heat medium at the other end, and
the heat-exchange pipe is arranged to extend from the first input/output port, go through an outer circumferential region of the battery, and further through a central region of the battery, and then reach the second input/output port.

5. The battery temperature adjusting device according to claim 1, wherein
the heat-exchange part includes a first input/output port and a second input/output port, through which the heat medium flows in and out, and
when warming the battery, the circuit switching unit switches to connecting the warming circuit to the heat-exchange part, allowing the heat medium to flow from the first input/output port to the second input/output port, and
when cooling the battery, the circuit switching unit switches to connecting the cooling circuit to the heat-exchange part, allowing the heat medium to flow from the second input/output port to the first input/output port.

6. The battery temperature adjusting device according to claim 2, wherein
the heat-exchange part includes a first input/output port and a second input/output port, through which the heat medium flows in and out, and
when warming the battery, the circuit switching unit switches to connecting the warming circuit to the heat-exchange part, allowing the heat medium to flow from the first input/output port to the second input/output port, and
when cooling the battery, the circuit switching unit switches to connecting the cooling circuit to the heat-exchange part, allowing the heat medium to flow from the second input/output port to the first input/output port.

7. The battery temperature adjusting device according to claim 3, wherein
when warming the battery, the circuit switching unit switches to connecting the warming circuit to the heat-exchange part, allowing the heat medium to flow from the first input/output port to the second input/output, and
when cooling the battery, the circuit switching unit switches to connecting the cooling circuit to the heat-exchange part, allowing the heat medium to flow from the second input/output to the first input/output port.

8. The battery temperature adjusting device according to claim 4, wherein
when warming the battery, the circuit switching unit switches to connecting the warming circuit to the heat-exchange part, allowing the heat medium to flow from the first input/output port to the second input/output, and
when cooling the battery, the circuit switching unit switches to connecting the cooling circuit to the heat-exchange part, allowing the heat medium to flow from the second input/output to the first input/output port.

9. The battery temperature adjusting device according to claim 1, wherein
the battery is provided with a plurality of the heat-exchange parts each including a first input/output port and a second input/output through which the heat medium flows in and out,
the warming circuit is configured to flow the heat medium with the raised temperature to the heat-exchange parts to warm the battery,
the cooling circuit is configured to flow the cooled heat medium to the heat-exchange parts to cool the battery,
each of the heat-exchange parts is provided with an electromagnetic valve in at least one of the first input/output port and the second input/output,
the battery temperature adjusting device further comprises a control unit for controlling the circuit switching unit and a plurality of the electromagnetic valves, and
the control unit is configured to:
when a request for warming the battery exists, control the circuit switching unit to connect the warming circuit to the heat-exchange parts and control the electromagnetic valves, and
when a request for cooling the battery exists, control the circuit switching unit to connect the cooling circuit to the heat-exchange part and control the electromagnetic valves.

10. The battery temperature adjusting device according to claim 9, wherein
the heat-exchange parts are arranged in the battery so that the heat medium flows at a higher flow rate through a central region of the battery than other regions when cooling the battery, and the heat medium flows at a higher flow rate through an outer circumferential region than other regions when warming the battery.
